(19) United States
(12) Patent Application Publication
(10) Pub. No.: US 2025/0310465 A1
(43) Pub. Date: Oct. 2, 2025

(54) NON-TRANSITORY COMPUTER-READABLE STORAGE MEDIUM, INFORMATION PROCESSING METHOD, AND INFORMATION PROCESSING APPARATUS

(71) Applicant: CANON KABUSHIKI KAISHA, Tokyo (JP)

(72) Inventor: KEITA HIDAKA, Ibaraki (JP)

(21) Appl. No.: 19/090,227

(22) Filed: Mar. 25, 2025

(30) Foreign Application Priority Data
Mar. 28, 2024 (JP) 2024-053436

(51) Int. Cl. H04N 1/44; H04N 1/00; H04N 1/387

(52) U.S. Cl. CPC H04N 1/4493; H04N 1/0044; H04N 1/00816; H04N 1/00824; H04N 1/3872

(57) ABSTRACT

A non-transitory computer-readable storage medium storing an application program which causes an information processing apparatus to perform a control method, the application program supporting scan software which is able to be used with a plurality of image processing apparatuses supplied from a plurality of manufacturers, the control method includes displaying a display screen that receives a setting to hide part of a read image, and outputting reading instructions to an image reading apparatus to perform a scan in accordance with the setting received on the display screen.

### BACKGROUND

### Field

The present disclosure relates to a non-transitory computer-readable storage medium, an information processing method, and an information processing apparatus that extend or support the functions of general-purpose scan software which is commonly able to be used with image reading apparatuses supplied from a plurality of manufacturers.

### Description of the Related Art

There is a known configuration in which scan drivers installed on a host computer as control software for scan apparatuses (image reading apparatuses) are used to give reading instructions to the scan apparatuses connected to the host computer.

The host computer has an operating system (OS) that is basic software installed therein. The scan drivers are configured in accordance with the specifications predefined by the OS and operate when called by the OS. Vendors (manufacturers) that provide scan apparatuses can provide scan drivers compatible with the specifications of the OS to provide a method to instruct the scan apparatuses to perform reading using the OS.

In recent years, a standard class driver (also referred to as a “standard driver”) which is commonly able to be used with multiple vendors' scan apparatuses is about to be provided on Windows® of Microsoft®.

Such a standard driver is included in the OS package and is easily usable by connecting any scan apparatus to the host computer. Therefore, there is no need to separately install model-specific scan drivers that are respectively suitable for scan apparatuses, so it is highly convenient.

Furthermore, it is expected that the standard driver will be configured to allow the designation of scan functions in accordance with scan function information generated based on information acquired from a connected scan apparatus. This allows a user who uses the standard driver to designate scan functions according to the capabilities of the connected scan apparatus, even though they are using one standard driver. However, this is limited to functions that can be achieved by the standard driver only, so it is not possible to designate functions unique to scan vendors.

Japanese Patent Laid-Open No. 2021-033526 discloses a program that extends the printing function of general-purpose software.

Like printer drivers, a program that extends the scan functions of general-purpose software (standard driver) will be discussed for scan drivers as well.

Examples of the functions of scan drivers, unique to scan vendors, include a cropping setting and a masking setting.

Cropping is a function that makes it possible to designate a certain region in a document to acquire an image. By using this function to perform cropping, it is possible to acquire an image that excludes parts not used in the document. However, the functions that can be achieved by the standard driver only do not include the cropping setting. Therefore, with only the standard driver, it is not possible to acquire only the image of a region used through cropping.

Masking is a function that makes it possible to designate and fill in a certain region in an image. By using this function to perform masking, it is possible to hide a certain content of a scanned image. However, the functions that can be achieved by the standard driver only do not include a masking setting. Therefore, with only the standard driver, it is not possible to use the masking function.

When the functions that can be achieved by the standard driver only do not include a preview function, it is not possible to use the preview function with the standard driver only.

In this way, with the existing technology, it was not possible to use functions to hide part of a read image, such as the cropping function and the masking function, or to use the preview function.

The present disclosure is made to address the above inconvenience. The present disclosure provides a mechanism that allows a user to use at least one of a function that hides part of a read image, such as a cropping function and a masking function, and a preview function even when general-purpose scan software which is commonly able to be used with scan apparatuses supplied from a plurality of manufacturers does not support the function.

### SUMMARY

An aspect of the present disclosure provides a non-transitory computer-readable storage medium storing an application program which causes an information processing apparatus to perform a control method, the application program supporting scan software which is able to be used with a plurality of image processing apparatuses supplied from a plurality of manufacturers. The control method includes displaying a display screen that receives a setting to hide part of a read image, and outputting reading instructions to an image reading apparatus to perform a scan in accordance with the setting received on the display screen.

Further features of the present disclosure will become apparent from the following description of exemplary embodiments with reference to the attached drawings.

### BRIEF DESCRIPTION OF THE DRAWINGS

FIG. 1 is a block diagram that illustrates the hardware configuration of a scan system according to an embodiment.

FIGS. 2A and 2B are block diagrams that schematically show the software configuration of the scan system according to the present embodiment.

FIGS. 3A and 3B are diagrams that illustrate scan settings screens when not using an extended application.

FIGS. 3C and 3D are diagrams that illustrate scan settings screens when using the extended application.

FIGS. 3E and 3F are diagrams that illustrate scan settings screens when using the extended application.

FIGS. 3G and 3H are diagrams that illustrate scan settings screens when using the extended application.

FIG. 4 is a flowchart that shows a process in which a scan function extension unit according to a first embodiment edits scan function information.

FIG. 5A is a table that illustrates capability information acquired from a scan apparatus, scan functions supported by the extended application, and scan functions supported by general-purpose scan software.

FIG. 5B is a table that illustrates capability information acquired from a scan apparatus and scan functions supported by the extended application.

FIG. 6 is a diagram that illustrates a scan processing sequence according to the first embodiment.

FIG. 7 is a flowchart that shows a scan process executed by the extended application according to the first embodiment.

FIG. 8 is a flowchart that shows a scan process of a scan apparatus according to the first embodiment.

FIG. 9A is a flowchart that shows a process in which a scan function extension unit according to a second embodiment edits scan function information.

FIG. 9B is a flowchart that shows a process in which the scan function extension unit according to the second embodiment edits scan function information.

FIG. 10 is a diagram that illustrates a scan processing sequence according to the second embodiment.

FIG. 11A is a flowchart that shows a scan process executed by the extended application according to the second embodiment.

FIG. 11B is a flowchart that shows another example of a scan process executed by the extended application according to the second embodiment.

FIG. 12 is a diagram that illustrates a scan processing sequence according to a third embodiment.

FIG. 13 is a diagram that illustrates a scan processing sequence in a case where image edit executed by an extended application according to the third embodiment is performed.

FIG. 14 is a diagram that illustrates a scan processing sequence according to a

fourth embodiment.

FIG. 15 is a flowchart that shows a scan process executed by an extended application according to the fourth embodiment.

FIG. 16 is a flowchart that shows an example of a process in which an extended application according to a sixth embodiment updates a preview image.

FIG. 17 is a diagram that shows a scan settings screen according to the sixth embodiment.

FIG. 18 is a diagram that illustrates a scan processing sequence according to the sixth embodiment.

FIG. 19 is a flowchart that shows a scan process executed by the extended application according to the sixth embodiment.

FIG. 20 is a diagram that illustrates another example of a different scan processing sequence according to the sixth embodiment.

FIG. 21 is a flowchart that shows another example of a scan process executed by the extended application according to the sixth embodiment.

### DESCRIPTION OF THE EMBODIMENTS

Hereinafter, embodiments of the present disclosure will be described with reference to the attached drawings. The following embodiments do not limit the present disclosure according to the appended claims, and not all the combinations of characteristics described in the present embodiments are indispensable for the solution of the present disclosure.

### First Embodiment

### Hardware Configuration of Scan System

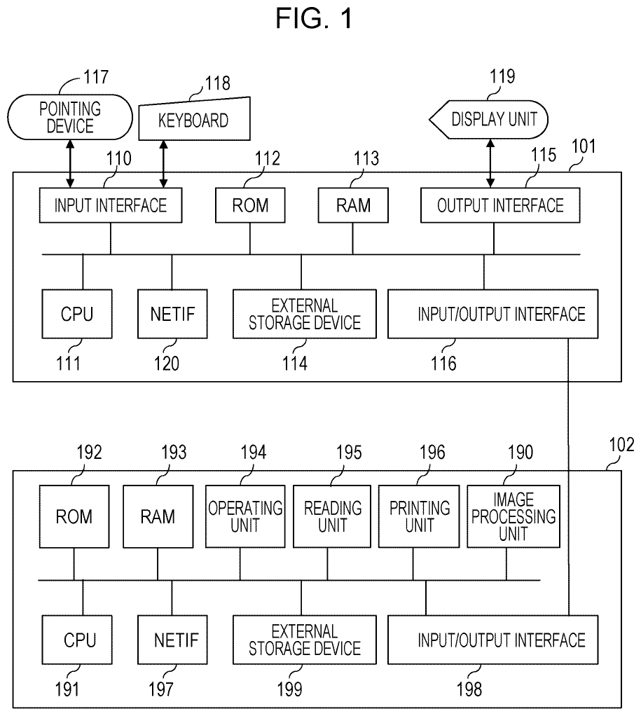

FIG. 1 is a block diagram that illustrates the hardware configuration of a scan system, which is an example of the present embodiment.

In FIG. 1, a host computer 101 is an example of an information processing apparatus. The host computer 101 includes an input interface 110, a CPU 111, a ROM 112, a RAM 113, an external storage device 114, an output interface 115, an input/output interface 116, and an NETIF 120. CPU is the abbreviation of central processing unit.

ROM is the abbreviation of read only memory. RAM is the abbreviation of random access memory.

Input devices such as a keyboard 118 and a pointing device 117 are connected to the input interface 110, and a display device such as a display unit 119 is connected to the output interface 115.

The NETIF 120 is a network interface and executes control for data transfer with an external device via a network.

An initialization program is stored in the ROM 112. The external storage device 114 is, for example, a hard disk drive (HDD) or a solid state drive (SSD). The external storage device 114 stores application programs, an operating system (OS), and other various data.

The RAM 113 is used as a working memory or the like in executing various programs stored in the external storage device 114, and various programs are operable in the host computer 101. In the present embodiment, the CPU 111 executes functions (described later) and flowcharts (described later) in the host computer 101 by executing processing in accordance with the code of the programs stored in the ROM 112 and the external storage device 114.

Devices such as a scan apparatus 102 can be connected to the input/output interface 116.

The scan apparatus 102 is an example of an image reading apparatus and is connected to the host computer 101 via an input/output interface 198 of the scan apparatus 102 and the input/output interface 116 of the host computer 101. The input/output interface 198 of the scan apparatus 102 and the input/output interface 116 of the host computer 101 may be connected by a wired network or a wireless network. The scan apparatus 102 may be configured to be connected to the host computer 101 via an NETIF 197 of the scan apparatus 102 and the NETIF 120 of the host computer 101.

The scan apparatus 102 includes a CPU 191, a ROM 192, a RAM 193, an operating unit 194, a reading unit 195, a printing unit 196, the NETIF 197, and the input/output interface 198.

The CPU 191 comprehensively controls the scan apparatus 102. The ROM 192 is a memory that stores programs. The RAM 193 is a memory that temporarily stores programs and image data. The operating unit 194 has hard keys and an operating screen (which may be a touch panel display), and presents information to a user and receives operation from the user.

The reading unit 195 is a scanner that reads an image on a document. The printing unit 196 prints an image onto a sheet based on image data. The printing unit 196 is not indispensable.

The image processing unit 190 executes various image editing processes on input image data.

The external storage device 199 is, for example, an HDD or an SSD. The external storage device 114 stores input image data and other various types of data.

The host computer 101 or the like can be connected to the input/output interface 198.

The NETIF 197 is a network interface and executes control for data transfer with an external device via a network.

Here, the host computer 101 and the scan apparatus 102 are separated. Alternatively, the host computer 101 and the scan apparatus 102 may be configured as a single information processing apparatus. A reading settings screen (described later) and an advanced settings screen (described later) are displayed on the display unit 119. In the present embodiment, an electrophotographic digital multifunction peripheral with multiple functions, such as copying, printing, and faxing, will be described as an example of the scan apparatus (image reading apparatus) 102. However, the scanning apparatus 102 is not limited to thereto. The present embodiment is applicable to devices that use other processes, such as an inkjet method, and scanners that perform only image reading.

The host computer 101 may be a personal computer (PC), such as a desktop PC and a laptop PC, a smartphone, or a tablet terminal.

### Configuration of Scan System Focusing on Software

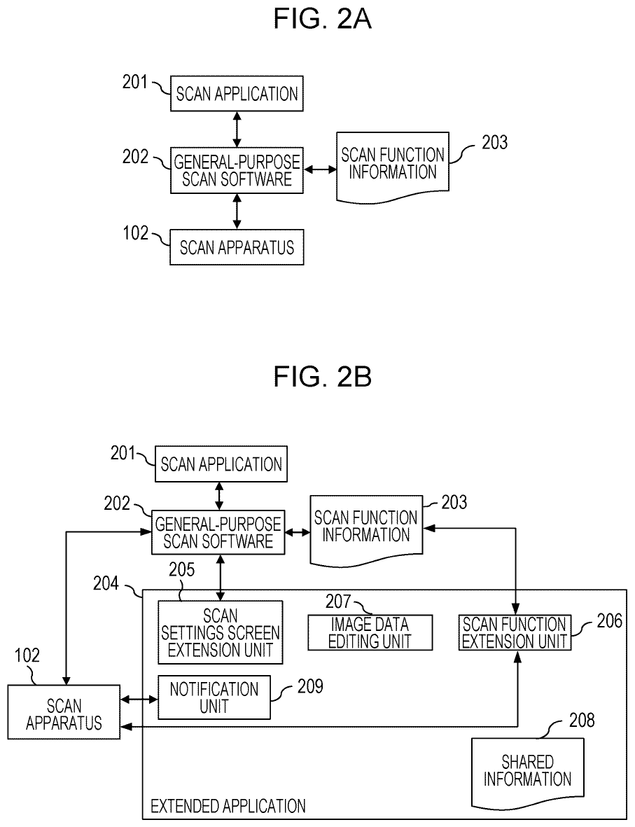

FIGS. 2A and 2B are block diagrams that schematically illustrate the software configuration of the scan system.

The software configuration in FIGS. 2A and 2B corresponds to the functions implemented in the host computer 101 by the CPU 111 reading programs stored in the external storage device 114 of FIG. 1 onto the RAM 113 and executing the programs. Here, the description will be made on the assumption that the scan system uses the host computer 101 on which Windows® 11 of Microsoft® is installed as OS; however, the OS is not limited thereto. In other words, the version of Windows® is not limited to 11, and any version that can apply the present disclosure is applicable.

The present disclosure may also be applied to operating systems other than Windows®.

FIG. 2A is a diagram that illustrates a general configuration in a case where an extended application 204 is not associated with general-purpose scan software 202 and the scan apparatus 102.

FIG. 2B is a block diagram that illustrates a configuration in a case where the extended application 204 is associated with the general-purpose scan software 202 and the scan apparatus 102.

The general-purpose scan software 202 is included (bundled) in the OS in advance. When the OS is installed on the host computer 101, the general-purpose scan software 202 is also available. The extended application 204 is software that extends or supports the functions of the general-purpose scan software 202 and that is not included (not bundled) in the OS in advance.

### Configuration of Scan System Focusing on Software (When Extended Application 204 is Not Associated)

First, the configuration of the scan system in a case where the extended application 204 is not associated will be described with reference to FIG. 2A.

A scan application 201 is software that captures scanned contents (image data). For example, a document creation application and an image edit application correspond to the scan application 201. The scan application 201 issues scan instructions to the OS (not shown) when receiving a scan request from a user. The scan instructions include scan settings information to provide instructions for the operations of the general-purpose scan software 202 and the scan apparatus 102.

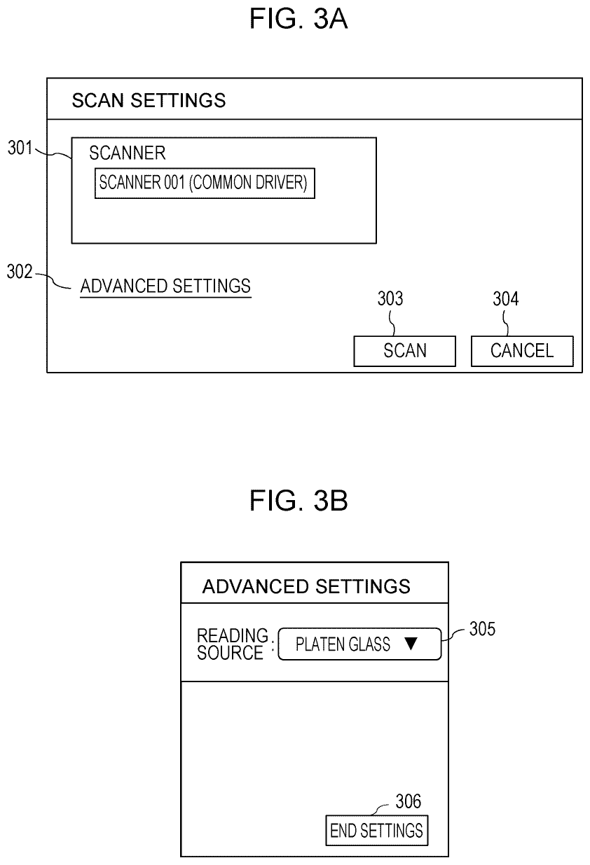

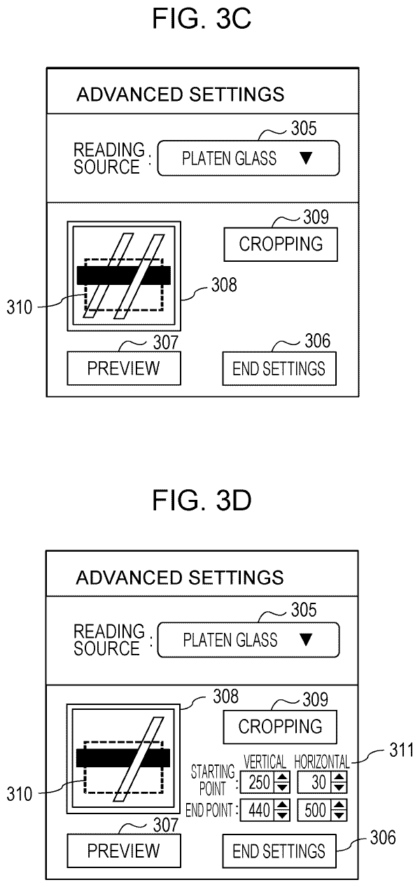

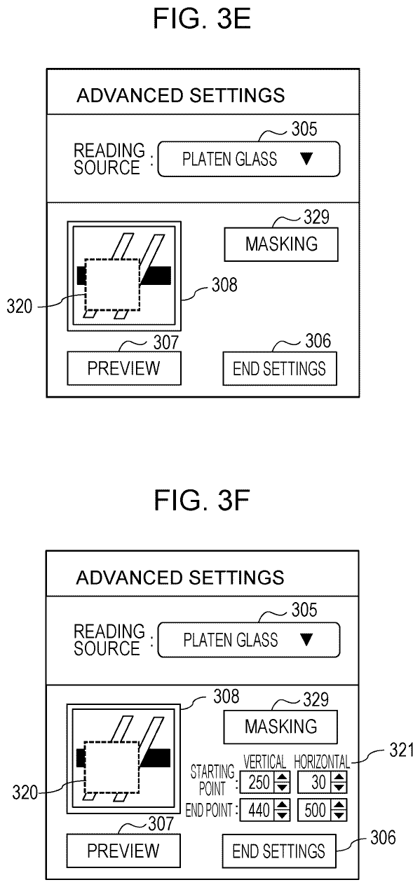

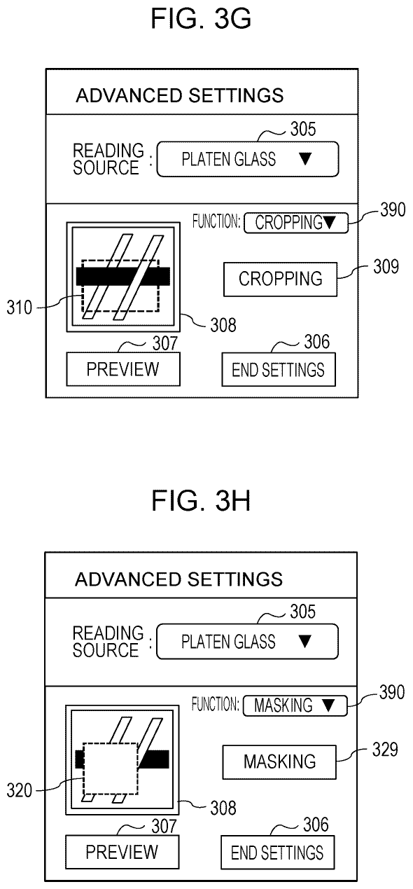

The scan application 201 is capable of displaying a scan settings screen provided by at least any one of the general-purpose scan software 202, the OS, and the scan application 201 to respond to scan instructions. When the advanced settings button on the scan settings screen is pressed, the general-purpose scan software 202 additionally displays an advanced settings screen. The scan settings screen and the advanced settings screen will be described later with reference to FIG. 3A to FIG. 3H.

The advanced settings screen includes setting items (hereinafter, also referred to as control items) that indicate the settable scan functions and control items that indicate their setting values, based on the capability information (settable information) of the general-purpose scan software 202. The general-purpose scan software 202 determines the scan capabilities based on the scan function information 203.

The scan function information 203 is data that indicates all the settable scan functions, their setting values, and the exclusive relationship between the setting values. The scan function information 203 is included in the configuration file of the general-purpose scan software 202 and is placed on the external storage device 114 as an unchangeable file. Alternatively, the general-purpose scan software 202 or the OS can also dynamically generate the scan function information 203. Specifically, the general-purpose scan software 202 or the OS may be configured to acquire the attribute data of the scan apparatus 102 from the scan apparatus 102 and generate the scan function information 203 in accordance with the attribute information in the acquired attribute data. When the scan function information 203 is generated dynamically, the generated scan function information 203 is editable. In the present embodiment, the description will be made on the assumption that the general-purpose scan software 202 or the OS dynamically generates the scan function information 203.

The attribute data of the scan apparatus 102, acquired from the scan apparatus 102, includes attribute information that indicates functions allowed to be designated for the scan apparatus 102 (capabilities of the scan apparatus 102), and setting values related to the attribute information. These pieces of information are saved in the RAM 113.

With this configuration, the general-purpose scan software 202 allows the user to designate scan functions available in each scan apparatus 102 according to the connected scan apparatus 102. In other words, even when scan apparatuses with different functions or scan apparatuses developed by different vendors are connected, the general-purpose scan software 202 allows the user to designate available scan functions according to the connected scan apparatuses. In other words, vendors may be manufacturers of scan apparatuses 102. Here, a standard class driver that performs a scan based on a standard scan protocol called Mopria is used as the general-purpose scan software 202.

The general-purpose scan software 202 acquires the capability information of the connected scan apparatus 102 in order to allow the user to designate scan functions supported by the connected scan apparatus 102, and generates the scan function information 203 based on that information. However, the general-purpose scan software 202 does not support a cropping setting function or a masking setting function. This is because the cropping setting function and the masking setting function are unique to vendors of the scan apparatuses (manufacturers of the scan apparatuses).

### Cropping Setting Function

The cropping setting function is a function capable of cropping a designated region in an image and hiding a part not used. In other words, the cropping setting function is a function capable of hiding part of a read image. By using this function, a user is able to remove a part not used from a document and acquire only the image of a part used. A region to be cropped is not limited to one in a single image, and there is also a known configuration that a plurality of regions can be cropped. Although described in detail later, in the first embodiment, the configuration in which a cropping region is designated while checking a preview image acquired by performing a preview scan once with the scan apparatus 102 and performing a scan based on the designated cropping region will be discussed.

### Masking Setting Function

The masking setting function is a function capable of filling in a designated region in an image and hiding the designated region. In other words, the masking setting function is a function capable of hiding part of a read image. By using this function, a user is able to hide part of a content by filling in a part not used in a document. A region to be masked is not limited to one in a single image, and there is also a known configuration that a plurality of regions can be masked. Although described in detail later, in the first embodiment, the configuration in which a masking region is designated while checking a preview image acquired by performing a preview scan once with the scan apparatus 102 and performing a scan based on the designated masking region will be discussed.

### Configuration of Scan System Focusing on Software (When Extended Application 204 is Associated)

Next, the configuration of the scan system in a case where the extended application 204 is associated will be described with reference to FIG. 2B. The configurations and processes that are not specifically mentioned below are equivalent to those of FIG. 2A.

The extended application 204 is software for extending the functions of the general-purpose scan software 202 and is a program that is not included (not bundled) in the OS in advance. Therefore, a user operates the host computer 101, downloads the extended application 204 from a server or the like via the Internet, and installs the extended application 204. Alternatively, the extended application 204 may be automatically installed based on the fact that the scan apparatus 102 is connected to the host computer 101. Specifically, when the scan apparatus 102 is connected to the host computer 101, the OS acquires device identification information from the scan apparatus 102. The OS may download and install the extended application 204 corresponding to the acquired device identification information from a server via the Internet. In other words, the general-purpose scan software 202 and the extended application 204 are held in the host computer 101 as separate files.

The general-purpose scan software 202 and the extended application 204 may be updated and upgraded, and this process of updating is also performed at different timings. In other words, the timing at which the general-purpose scan software 202 is acquired by the host computer 101 and the timing at which the extended application 204 is acquired by the host computer 101 are different. A trigger for acquiring the general-purpose scan software 202 with the host computer 101 and a trigger for acquiring the extended application 204 with the host computer 101 are also different. When the extended application 204 is installed, the OS associates the extended application 204 with the general-purpose scan software 202 and the scan apparatus 102.

The extended application 204 described in the present embodiment includes a scan settings screen extension unit 205, a scan function extension unit 206, an image data editing unit 207, and a notification unit 209. The extended application 204 has shared information 208 that can be commonly accessed from each unit. The entity of the shared information 208 is a file saved in the external storage device 114 or information stored in the RAM 113. The extended application 204 writes and reads information to and from the shared information 208 by using an application program interface (API) provided by the OS.

The extended application 204 may terminate its operation each time the processing of each unit completes. In this case, each time a request to use each unit is received, the OS launches the extended application 204.

Furthermore, the extended application 204 may cancel processing in the middle of the processing of each unit. When canceled, a job in process is discarded by the OS.

When the scan application 201 receives a scan request from a user, the scan application 201 issues scan instructions to the OS. Even with this configuration, as in the case of the configuration of FIG. 2A, the scan application 201 can display a scan settings screen. With this configuration, when the advanced settings button in the scan settings screen is pressed, the advanced settings screen provided by the extended application 204 is displayed. Specifically, the advanced settings screen provided by the scan settings screen extension unit 205 of the extended application 204 is displayed. The scan settings screen extension unit 205 can save the advanced settings set by the user in the shared information 208.

The extended application 204 includes the image data editing unit 207. The image data editing unit 207 acquires image data from the scan apparatus 102 and edits the image data. The image data editing unit 207 acquires advanced settings information from the shared information 208 and executes image edit on the image data in accordance with the advanced settings. The extended application 204 may be configured to acquire image data obtained by the general-purpose scan software 202 and execute image edit on the image data in accordance with the advanced settings. There are cases where a cropping setting or a masking setting is not performed depending on a user in the configuration of FIG. 2B. In this case, the general-purpose scan software 202 may output scan request instructions to the scan apparatus 102 without intervening the extended application 204 as in the case of the configuration of FIG. 2A.

The extended application 204 includes the scan function extension unit 206. The scan function extension unit 206 can edit the scan function information 203 generated by the general-purpose scan software 202 or the OS. Thus, the scan function extension unit 206 can add additional functions provided by the extended application 204. The scan function extension unit 206 can, for example, add functions supported by the scan apparatus 102 but not supported by the general-purpose scan software 202 (such as a cropping setting function and a masking setting function) and add the exclusive relationship between the setting values of scan functions. The OS launches the scan function extension unit 206 when the extended application 204 is associated with the scan apparatus 102 and the general-purpose scan software 202 for the first time. Furthermore, the OS may launch the scan function extension unit 206 at other timings, such as when the OS starts up.

The extended application 204 includes the notification unit 209. The notification unit 209 is capable of displaying a notification to the user in response to the occurrence of error in the scan apparatus 102. For example, when a reading jam error occurs in the scan apparatus 102, the general-purpose scan software 202 detects the error, and the OS uses a notification function called a toast notification that is the function of the OS to display a message on the display unit 119. When the user presses the toast notification, the notification unit 209 of the extended application 204 is called by the OS, and a UI screen of the notification unit 209 is displayed. The UI screen of the notification unit 209 is capable of, for example, displaying a detailed message of a scan jam error and a jam releasing method.

The configuration of the extended application 204 for implementing the present embodiment is not limited to having all of the above-described functions (units), and may also have only some of the functions or have other functions. The extended application 204 is sometimes simply referred to as scan software. As described above, the extended application 204 has at least one of the following functions. The first one is a function that displays a setting screen (scan settings screen extension unit 205). The second one is a function that edits image data in accordance with advanced settings (image data editing unit 207). The third one is a function that extends functions that can be designated by image data generation software (scan function extension unit 206). The fourth one is a function that displays a screen in response to the occurrence of error in the scan apparatus 102 (notification unit 209).

### Example of Scan Settings Screen/Advanced Settings Screen

Next, examples of the scan settings screen and the advanced settings screen in the present embodiment will be described with reference to FIGS. 3A to 3H. Hereinafter, FIGS. 3A to 3H are collectively referred to as FIG. 3.

FIG. 3A is a diagram that illustrates a scan settings screen displayed on the display unit 119 of the host computer 101 by the scan application 201.

FIG. 3B is a diagram that illustrates an advanced settings screen displayed on the display unit 119 of the host computer 101 in a case where there is no extended application 204 shown in FIG. 2A.

FIGS. 3C to 3H are diagrams that illustrate advanced settings screens displayed on the display unit 119 of the host computer 101 in a case where there is the extended application 204 shown in FIG. 2B.

The unit or module that displays a scan settings screen is not limited to the above. For example, the scan settings screen extension unit 205 may be configured to generate only a display screen. In this case, the scan settings screen extension unit 205 transmits a generated display screen to the scan application 201 via the general-purpose scan software 202. The scan application 201 may be configured to display the acquired display screen. FIG. 3A Scan Settings Screen Displayed by Scan Application 201

On the scan settings screen of FIG. 3A, a control 301 has objects to allow a user to set a scanner that performs a scan (a scanner apparatus used for reading). A control 303 is a scan start button for starting a scan.

A control 304 is a cancel button for cancelling a scan. A control 302 is an advanced settings button. When the control 302 is pressed, an additional scan screen is displayed on the display unit 119 by the general-purpose scan software 202 or the scan settings screen extension unit 205.

### FIG. 3B Advanced Settings Screen Displayed by General-Purpose Scan Software 202

FIG. 3B is an additional settings screen (advanced settings screen) displayed by the general-purpose scan software 202 when there is no extended application 204. A control 305 indicates that a reading source can be set and a platen glass is selected. A control 306 is a setting end button. When the control 306 is pressed, the screen returns to the scan settings screen of FIG. 3A.

### FIG. 3C Scan Settings Screen Displayed by Scan Settings Screen Extension Unit 205

FIG. 3C is an example of an additional settings screen (advanced settings screen) displayed by the scan settings screen extension unit 205 in a case where there is the extended application 204.

The advanced settings screen of FIG. 3C is different from FIG. 3B and includes a preview instruction button 307, a preview image display region 308, and a cropping setting button 309.

When the preview instruction button 307 is pressed, the extended application 204 executes control such that the scanner device set by the control 301 scans a document based on current setting information, and displays the scanned image in the preview image display region 308. In other words, display instructions to display a preview image of a read image are received by the preview instruction button 307.

When the cropping setting button 309 is pressed, the extended application 204 executes control such that a cropping setting region 310 is changeable by dragging with, for example, the pointing device 117 in the preview image display region 308. In other words, it is possible to designate a cropping region in accordance with a region designated on a preview image. The extended application 204 executes control such that coordinate information indicating the cropping setting region 310 designated in this way is stored in the RAM 113.

As another configuration, as shown in FIG. 3D, input forms and spin buttons 311 may be provided, and coordinates of a cropping region may be input as numeric values (for example, numeric values indicating a starting point and an end point). As another configuration, it is also applicable that a cropping region is input as numeric values indicating the position of a cropping region (which may be center coordinates, top-left coordinates, or the like) and the size. In these cases, the extended application 204 stores input coordinate information in the RAM 113. The extended application 204 changes the view of the cropping setting region 310 based on the values of the input forms 311. On the other hand, when the cropping setting region 310 is changed by dragging, the extended application 204 changes the values of the input forms 311 based on the changed cropping setting region 310.

When preview images of a plurality of documents are displayed, a plurality of preview images may be displayed in the preview image display region 308 or a preview image displayed may be switched with a button. In these cases, it is possible to set a cropping setting region 310 for each preview image, and the extended application 204 saves a cropping setting in the RAM 113 in association with a page number.

### FIG. 3E Another Example of Scan Settings Screen Displayed by Scan Settings Screen Extension Unit 205

FIG. 3E is another example of an additional settings screen (advanced settings screen) displayed by the scan settings screen extension unit 205 in a case where there is the extended application 204.

The advanced settings screen of FIG. 3E is different from FIG. 3B and includes a preview instruction button 307, a preview image display region 308, and a masking setting button 329. The description of the preview instruction button 307 is omitted because it is similar to FIG. 3C.

When the masking setting button 329 is pressed, the extended application 204 allows changing of a masking setting region 320 by dragging with, for example, the pointing device 117 in the preview image display region 308. In other words, it is possible to designate a masking region in accordance with a region designated on a preview image. The extended application 204 executes control such that coordinate information indicating the masking setting region 320 designated in this way is stored in the RAM 113.

As another configuration, input forms and spin buttons 321 may be provided as shown in FIG. 3F, and the coordinates of a masking region may be input as numeric values (for example, numeric values indicating a starting point and numeric values indicating an end point). As another configuration, it is also applicable that a masking region is input as numeric values indicating the position of the masking region (which may be center coordinates, top-left coordinates, or the like) and the size. In these cases, the extended application 204 stores input coordinate information in the RAM 113. The extended application 204 changes the view of the masking setting region 320 based on the values of the input forms 321. On the other hand, when the masking setting region 320 is changed by dragging, the extended application 204 changes the values of the input forms 321 based on the changed masking setting region 320.

As another configuration, when the capability information of the scan apparatus 102 and the extended application 204 allows the designation of filling color in masking, a button with which a color used to fill in a region can be designated in masking may be provided. A color may be designated by, for example, selecting from among color candidates displayed or inputting RGB values; however, designation of a color is not limited thereto. In this way, when a color to fill in a region in masking is designated on the scan settings screen displayed by the extended application 204, the extended application 204 incorporates instructions to designate a color to fill in a region in masking into a scan instruction command to be output to the scan apparatus 102.

FIGS. 3E and 3F show an example in which the masking setting region 320 is filled in with white and displayed. As another configuration, the masking setting region 320 may be displayed by blinking the inside of the region, or may be displayed by displaying only the frame of the region, or may be displayed by filling in with a specific color. Furthermore, it is also applicable to display a preview with the inside of the masking setting region 320 filled in with the designated color upon reception of the designation of a filling color.

When preview images of a plurality of documents are displayed, a plurality of preview images may be displayed in the preview image display region 308 or a preview image displayed may be switched with a button. In these cases, it is possible to set a masking setting region 320 for each preview image, and a masking setting is saved in the RAM 113 in association with a page number.

As another configuration, the extended application 204 may be configured to display an advanced settings screen that combines FIGS. 3C and 3E. For example, it is applicable that an advanced settings screen that has both the cropping setting button 309 and the masking setting button 329 is displayed and both the cropping setting region 310 and the masking setting region 320 are settable in the preview image display region 308.

As another configuration, as shown in FIGS. 3G and 3H, a control 390 for changing the function to be set may be provided, and the advanced settings screen may be switched in accordance with the function selected by the control 390 as, for example, shown in FIGS. 3G and 3H. In this configuration as well, both the cropping setting region 310 and the masking setting region 320 may be settable.

Here, the reason why the scan setting items are different between FIG. 3B and FIGS. 3C and 3E will be described. Hereinafter, the description will be made with reference to FIGS. 3C and 3E, and the same applies to FIGS. 3D and 3F or FIGS. 3G and 3H.

The advanced settings screen is generated by referring to scan capabilities generated based on the scan function information 203. However, the general-purpose scan software 202 does not support the cropping setting function or the masking setting function, so the cropping setting function or the masking setting function cannot be added to the scan function information 203. Even when the scan function information 203 originally includes a cropping setting function or a masking setting function, the general-purpose scan software 202 cannot interpret the cropping setting function or the masking setting function included in the scan function information 203, so the cropping setting function or the masking setting function cannot be displayed on the advanced settings screen.

Therefore, in the present embodiment, for example, the configuration in which the scan function extension unit 206 adds a cropping setting function to the scan function information 203 and the scan settings screen extension unit 205 displays the advanced settings screen by consulting the scan capabilities will be described. With this configuration, the extended application 204 can display a cropping setting on the advanced settings screen. FIG. 3C may also include an additional extended function other than the cropping setting function.

In the present embodiment, the configuration in which the scan function extension unit 206 adds a masking setting function to the scan function information 203 and the scan settings screen extension unit 205 displays the advanced settings screen by consulting the scan capabilities will be described. With this configuration, the extended application 204 can display a masking setting on the advanced settings screen. FIG. 3E may also include an additional extended function other than the masking setting function.

### Flowchart of Scan Function Extension Unit 206 That Edits Scan Function Information 203

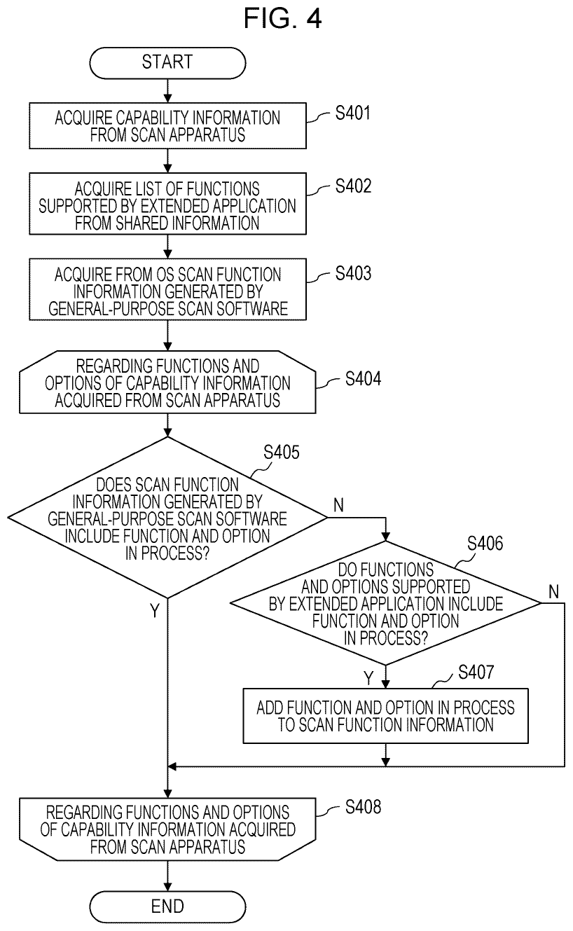

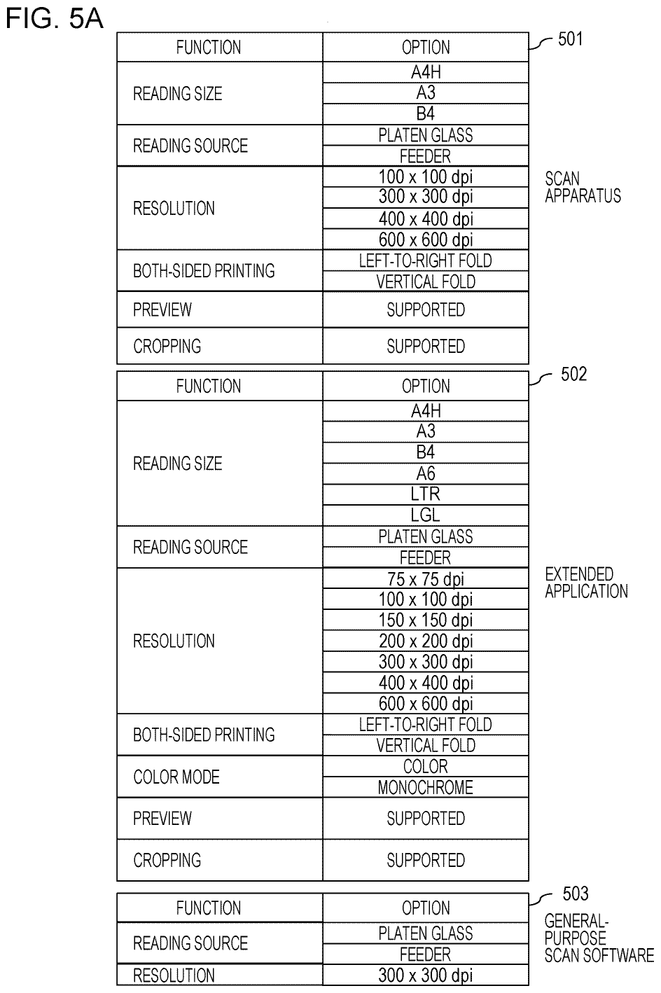

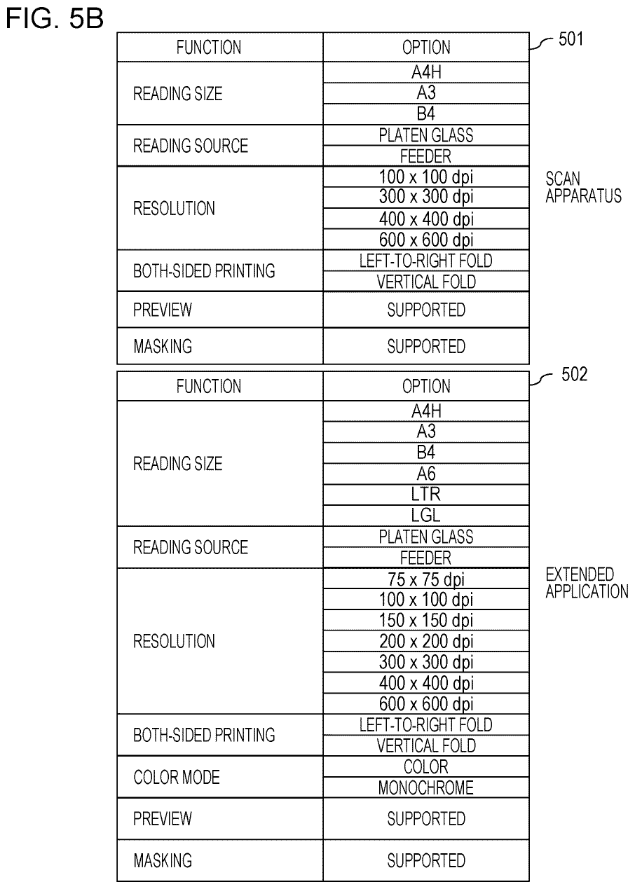

Here, the process flow in which the scan function extension unit 206 edits the scan function information 203 will be described with reference to FIGS. 4, 5A, and 5B.

FIG. 4 is a flowchart that shows an example of a process in which the scan function extension unit 206 according to the first embodiment edits the scan function information 203. Each step of this flowchart is implemented by executing each unit read from the external storage device 114 onto the RAM 113 by the CPU 111.

FIG. 5A is a table that shows an example of a list of capability information acquired from the scan apparatus 102 according to the first embodiment and a list of scan functions supported by the extended application 204.

First, in S401, the scan function extension unit 206 acquires capability information from the scan apparatus 102. Capability information includes attribute information that indicates functions that can be designated by the scan apparatus 102 and setting values associated with the attribute information.

Table 501 of FIG. 5A shows an example of a list of capability information acquired from the scan apparatus 102. As shown in Table 501, the scan function extension unit 206 can acquire functions such as reading size designation and settable options for each function from the scan apparatus 102.

Subsequently, in S402, the scan function extension unit 206 acquires a list of scan functions supported by the extended application 204 from the shared information 208. The list of scan functions supported by the extended application 204 is stored in the shared information 208, and contains all the scan functions processable by the extended application 204 and their setting values.

Table 502 of FIG. 5A shows an example of a list of scan functions supported by the extended application 204. The list of scan functions supported by the extended application 204 may also be updated through updates or the like of the extended application 204.

Subsequently, in S403, the scan function extension unit 206 acquires the scan function information 203 created by the general-purpose scan software 202 from the OS.

Table 503 of FIG. 5A shows an example of a list of scan functions supported by the general-purpose scan software 202.

The scan function information 203 created by the general-purpose scan software 202 is created based on the capability information 501 acquired by the general-purpose scan software 202 from the scan apparatus 102. However, the scan function information 203 created by the general-purpose scan software 202 includes only the scan functions supported by the general-purpose scan software 202, of the capability information acquired from the scan apparatus 102, so the functions of the scan function information 203 are limited. For example, the capability information 501 acquired from the scan apparatus 102 includes a preview function and a cropping setting function, but the general-purpose scan software 202 does not support the preview function or the cropping setting function. Therefore, when the scan function extension unit 206 adds functions and options to the scan function information 203, the extended application 204 can compensate for the insufficient functions of the general-purpose scan software 202. The scan function extension unit 206 can also remove functions and options not used from the scan function information 203 created by the general-purpose scan software 202.

Subsequently, in S404 and S408, the scan function extension unit 206 executes control to repeat processing shown in S405 to S407 for each function and option of the capability information acquired from the scan apparatus 102 in S401. In the example shown in Table 501, the processing shown in S405 to S407 is repeated for 13 types, that is, “reading size: A4H” to “cropping: supported” included in Table 501. First, the scan function extension unit 206 selects one of unprocessed items from among the functions and options of the capability information acquired from the scan apparatus 102 in S401 and advances the process to S405.

In S405, the scan function extension unit 206 determines whether the function and option in process is present in the scan function information 203 generated by the general-purpose scan software 202. In the example of FIG. 5A, for example, the determination is affirmative because the “reading source: platen glass” shown in Table 501 that is the capability information of the scan apparatus 102 is also present in Table 503 that is the capability information of the general-purpose scan software 202. On the other hand, the determination is negative because the “reading size: A4H” shown in Table 501 is not present in Table 503.

Here, when the scan function extension unit 206 determines in S405 that the function and option in process is present in the scan function information 203 generated by the general-purpose scan software 202 (when the determination is affirmative in S405), the scan function extension unit 206 advances the process to the next function and option.

On the other hand, when the scan function extension unit 206 determines in S405 that the function and option in process is not present in the scan function information 203 generated by the general-purpose scan software 202 (when the determination is negative in S405), the scan function extension unit 206 advances the process to S406.

In S406, the scan function extension unit 206 determines whether the function and option in process is present in the functions and options supported by the extended application 204. In the example shown in FIG. 5A, when, for example, the function in process is “cropping setting function”, the determination is affirmative because the “cropping setting function” is also present in Table 502 that is the capability information of the extended application 204.

Here, in S406, when the function and option in process is present in the functions and options supported by the extended application 204 (when the determination is affirmative in S406), the scan function extension unit 206 advances the process to S407.

In S407, the scan function extension unit 206 adds the function and option in process to the scan function information 203 and advances the process to the next function and option.

On the other hand, when the function and option in process is not present in the functions and options supported by the extended application 204 (when the determination is negative in S406), the scan function extension unit 206 directly advances the process to the next function and option.

When the scan function extension unit 206 advances the process to the next function and option, the scan function extension unit 206 selects the next one of the unprocessed items of the functions and options of the capability information acquired from the scan apparatus 102 in S401 and returns the process to S405 (S404, S408). When there is no unprocessed item in the functions and options of the capability information acquired from the scan apparatus 102, the scan function extension unit 206 ends processing of the flowchart of FIG. 4.

Here, the description will be made with reference to FIG. 5B in another example.

FIG. 5B is a table that shows another example of a list of capability information acquired from the scan apparatus 102 according to the first embodiment and a list of scan functions supported by the extended application 204. A list of scan functions supported by the general-purpose scan software 202 is the same as that of Table 503 of FIG. 5A. Hereinafter, only the differences from the case of FIG. 5A will be described.

In the case of the example of FIG. 5B, the capability information acquired from the scan apparatus 102 (501 in FIG. 5B) includes a preview function and a masking setting function, but the general-purpose scan software 202 indicated by 503 in FIG. 5A does not support a preview function or a masking setting function. Therefore, when the scan function extension unit 206 adds a preview function and a masking setting function to the scan function information 203, it is possible to use the preview function and the masking setting function. Hereinafter, the description will be specifically made with reference to the example of FIG. 5B.

In the example of FIG. 5B, a “preview display function” and a “masking setting function” shown in Table 501 that is the capability information of the scan apparatus 102 are not present in Table 503 that is the capability information of the general-purpose scan software 202. Therefore, when the “preview display function” or the “masking setting function” is a function in process, the determination is negative in S405 of FIG. 4. The “preview display function” and the “masking setting function” are present in Table 502 that is the capability information of the extended application 204, so the determination is affirmative in S406. Then, in S407, the “preview display function” and the “masking setting function” are added to the scan function information 203.

As described above, the scan function extension unit 206 can add a function and option that is not supported by the general-purpose scan software 202 but supported by the scan apparatus 102 and the extended application 204 (such as the preview display function, the cropping function, and the masking function) to the scan function information 203. Based on the scan function information 203 edited by this processing, scan capabilities are generated by the general-purpose scan software 202. When the scan settings screen extension unit 205 generates a display screen based on the generated scan capabilities, an advanced settings screen as shown in FIGS. 3C to 3H can be displayed by extending functions that are not supported by the general-purpose scan software 202.

### Sequence After Scan Application 201 Receives Scan Settings

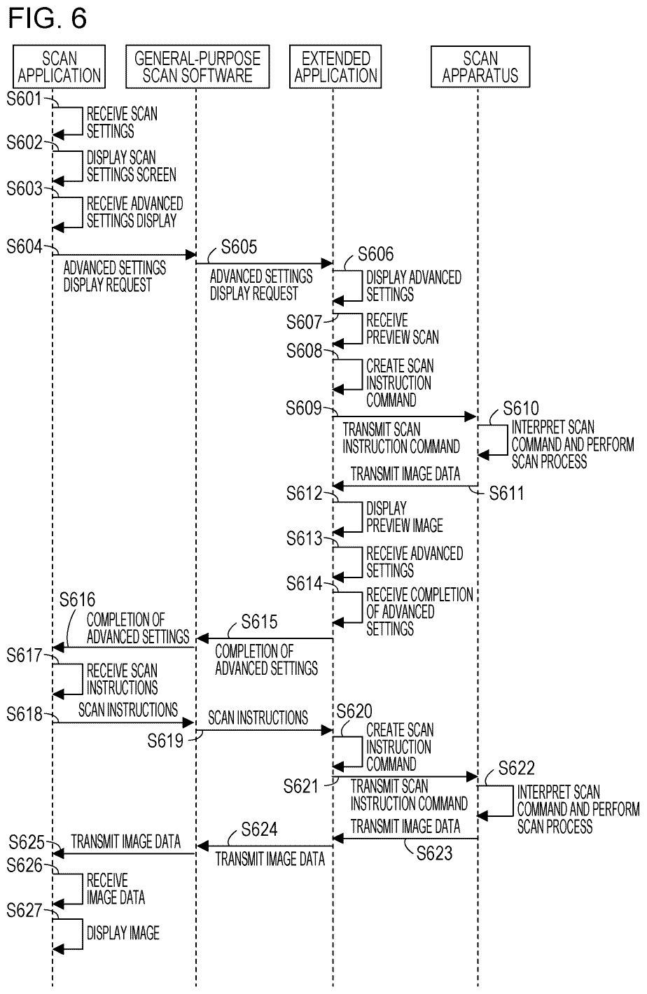

Next, the sequence of the scan application 201, the general-purpose scan software 202, the extended application 204, and the scan apparatus 102 after the scan application 201 receives scan settings will be described with reference to FIG. 6.

FIG. 6 is a diagram that illustrates the sequence of the scan application 201, the general-purpose scan software 202, the extended application 204, and the scan apparatus 102 after the scan application 201 receives scan settings. Steps other than steps performed by the scan apparatus 102 in FIG. 6 are implemented by the CPU 111 reading the scan application 201, the general-purpose scan software 202, and the extended application 204 from the external storage device 114 onto the RAM 113 and launching the software. Steps performed by the scan apparatus 102 in FIG. 6 are implemented by the CPU 191 of the scan apparatus 102 reading a program stored in the ROM 192 or the external storage device 199 onto the RAM 193 and running the program.

First, in S601, when the scan application 201 receives instructions for scan settings from a user, the scan application 201 advances the process to S602. The user is able to provide instructions for scan settings to the scan application 201 by operating the pointing device 117 and the keyboard 118.

In S602, the scan application 201 displays the scan settings screen shown in FIG. 3A on the display unit 119.

Subsequently, in S603, when the scan application 201 receives instructions for advanced settings, the scan application 201 advances the process to S604. The user is able to provide instructions for advanced settings by operating the pointing device 117 and the keyboard 118 to select the control 302.

In S604, the scan application 201 issues a request to display advanced settings to the general-purpose scan software 202. The general-purpose scan software 202 executes the processing of S605 in response to the request to display advanced settings.

In S605, the general-purpose scan software 202 issues a request to display advanced settings to the extended application 204. The extended application 204 executes the processing of S606 in response to the request to display advanced settings.

In S606, the scan settings screen extension unit 205 of the extended application 204 causes the display unit 119 to display the advanced settings screen. As described above, in the case of the configuration shown in FIG. 2B, the extended application 204 displays the advanced settings screen as shown in FIG. 3C or FIG. 3E. For example, the advanced settings screen as shown in FIG. 3C is displayed in the example of FIG. 5A, and the advanced settings screen as shown in FIG. 3E is displayed in the example of FIG. 5B. This is because, as described with reference to FIG. 4, functions (in the example of FIG. 5A, the preview function and the cropping function; in the example of FIG. 5B, the preview function and the masking function) are added to the scan function information 203 by the scan function extension unit 206. The scan settings screen extension unit 205 consults the scan capabilities generated based on the scan function information 203 after the addition and displays the advanced settings screen on the display unit 119. For example, the scan settings screen extension unit 205 causes the display unit 119 to display the advanced settings screen as shown in FIG. 3C in the example of FIG. 5A or FIG. 3E in the example of FIG. 5B.

Subsequently, in S607, the scan settings screen extension unit 205 receives preview operation through the preview instruction button 307.

Subsequently, in S608, the scan settings screen extension unit 205 provides instructions to write the advanced settings currently received for a preview scan to the scan settings information, and creates a preview scan instruction command based on the scan settings information. In the present embodiment, advanced settings may be received before S607, and, for example, as shown in FIG. 3C, the “reading source: platen glass” is selected by the user as shown in FIG. 3C as reading settings, the “reading source: platen glass” is selected by the user. Although not shown in FIG. 3C, another reading advanced settings item, such as a resolution setting, may be additionally received. It is also applicable to perform writing to the scan settings information together with items not causing the user to be selected. The received settings are stored in the RAM 113 by the CPU 111.

Subsequently, in S609, the extended application 204 sends the preview scan instruction command created in S608 to the scan apparatus 102 to provide preview scan instructions.

The scan apparatus 102 executes the processing of S610 in response to the preview scan instructions.

In S610, the scan apparatus 102 interprets the preview scan instruction command to perform a scan. In the present embodiment, a preview image is image data generated in the same processing as actual image data; however, when a preview scan instruction command is received, it is applicable to generate image data dedicated for preview. For example, in order to speed up preview display, there are methods, such as lowering the resolution below a setting and reducing the image size by increasing a compression ratio. This image generation process for a preview scan may be performed not in S610 but before an image is displayed in the preview image display region 308 in S612.

Subsequently, in S611, the scan apparatus 102 transmits the image data (preview image) generated by the scan process of S610 to the extended application 204. The extended application 204 executes the processing of S612 in response to reception of the image data.

In S612, the extended application 204 displays the received preview image in the preview image display region 308.

Subsequently, in S613, the scan settings screen extension unit 205 receives advanced settings. Hereinafter, the description will be made with reference to specific examples.

In a case where, for example, the advanced settings screen of FIG. 3C is displayed, when the cropping setting button 309 is selected, the scan settings screen extension unit 205 displays the cropping setting region 310 for the entire region in the preview image display region 308, and receives changes to the cropping setting region 310. In the present embodiment, the region is indicated by the dashed line. Alternatively, other indication methods, such as blinking the inside of the region, may be used. The user changes the position and size of the region by, for example, dragging the edge of the cropping setting region 310 with the pointing device 117. Data changes in conjunction with the cropping setting region 310 indicated by numeric values that represent the position and size of the region, such as the coordinates of the upper left and lower right corners of the region. When the scan settings screen extension unit 205 receives final coordinate data as a cropping setting, the scan settings screen extension unit 205 causes the CPU 111 to store the cropping setting in the RAM 113. Here, advanced settings other than the cropping setting, such as a reading source and a reading resolution, may be received.

As another configuration, it is also applicable that the cropping setting button 309 is not displayed in FIG. 3C and the cropping setting region 310 is allowed to be designated after a preview image is displayed.

As further another configuration, it is applicable that the cropping setting region 310 is allowed to be designated in the preview image display region 308 without displaying a preview image. Although accurate designation cannot be made since no preview image is displayed, the cropping setting region 310 is allowed to be designated without a preview scan, so it is possible to shorten user's setting time.

As another specific example, a case where the advanced settings screen of FIG. 3E is displayed will be described.

In this case, when the masking setting button 329 is selected, the scan settings screen extension unit 205 displays the masking setting region 320 for the entire region in the preview image display region 308, and receives changes to the masking setting region 320. In the present embodiment, the region is indicated by the dashed line. Alternatively, other indication methods, such as blinking the inside of the region, may be used. The user changes the position and size of the region by, for example, dragging the edge of the masking setting region 320 with the pointing device 117. Data changes in conjunction with the masking setting region 320 indicated by numeric values that represent the position and size of the region, such as the coordinates of the upper left and lower right corners of the region. When the scan settings screen extension unit 205 receives final coordinate data as a masking setting, the scan settings screen extension unit 205 causes the CPU 111 to store the masking setting in the RAM 113. Here, advanced settings other than the masking setting, such as a reading source and a reading resolution, may be received.

As another configuration, it is also applicable that the masking setting button 329 is not displayed in FIG. 3E and the masking setting region 320 is allowed to be designated after a preview image is displayed.

As further another configuration, it is applicable that the masking setting region 320 is allowed to be designated in the preview image display region 308 without displaying a preview image. Although accurate designation cannot be made since no preview image is displayed, the masking setting region 320 is allowed to be designated without a preview scan, so it is possible to shorten user's setting time.

Subsequently, in S614, when the scan settings screen extension unit 205 receives that the advanced settings are complete, the scan settings screen extension unit 205 provides instructions to write the received settings to the scan settings information. The user is able to provide instructions for completion of advanced settings by operating the pointing device 117 and the keyboard 118 to select the control 306.

Subsequently, in S615, the extended application 204 transmits, to the general-purpose scan software 202, that the advanced settings are complete. The general-purpose scan software 202 executes the processing of S616 in response to the notification of completion of advanced settings.

In S616, the general-purpose scan software 202 transmits, to the scan application 201, that the advanced settings are complete. The scan application 201 executes the processing of S617 in response to the notification about the completion of advanced settings.

In S617, when the scan application 201 receives scan instructions, the scan application 201 advances the process to S618. The user is able to provide instructions for a scan by operating the pointing device 117 and the keyboard 118 to select the control 503.

In S618, the scan application 201 provides scan instructions to the general-purpose scan software 202. The general-purpose scan software 202 executes the processing of S619 in response to the scan instructions.

In S619, the general-purpose scan software 202 provides scan instructions to the extended application 204. The extended application 204 executes the processing of S620 in response to the scan instructions.

In S620, the extended application 204 creates a scan instruction command based on the scan settings information written in S608.

Subsequently, in S621, the extended application 204 sends the scan instruction command created in S620 to the scan apparatus 102 to provide scan instructions. The scan apparatus 102 executes the processing of S622 in response to the scan instructions.

In S622, the scan apparatus 102 interprets the scan instruction command to perform a scan. The scan apparatus 102 executes image processing according to the scan instructions on the image data during scanning. When, for example, scan settings including a cropping setting as shown in FIG. 3C are made, the scan apparatus 102 performs cropping on the image scanned with the set reading size and generates image data of the designated region. When scan settings including a masking setting as shown in FIG. 3E are made, the scan apparatus 102 performs masking on the image scanned with the set reading size and generates image data with the designated region filled in.

Subsequently, in S623, the scan apparatus 102 transmits the image data generated by the scan of S622 to the extended application 204. The extended application 204 executes the processing of S624 when receiving the image data.

In S624, the extended application 204 transmits the received image data to the general-purpose scan software 202. The general-purpose scan software 202 executes the processing of S625 when receiving the image data.

In S625, the general-purpose scan software 202 transmits the received image data to the scan application 201. The scan application 201 executes the processing of S626 when receiving the image data.

In S626, the scan application 201 receives the received image data as a scan result.

Subsequently, in S627, the scan application 201 displays the image data received in S626.

The extended application 204 may be used as a simple preview scan function without performing a cropping setting or a masking setting in S613.

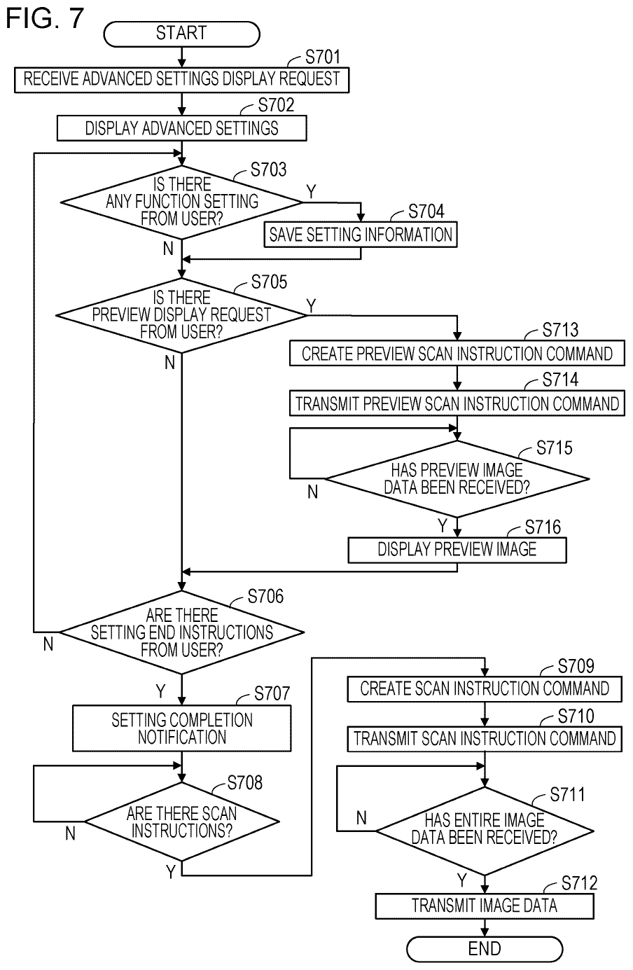

Here, the flow in which the extended application 204 executes a scan process will be described with reference to FIG. 7.

FIG. 7 is a flowchart that illustrates an example of the scan process executed by the extended application 204 in the first embodiment. Steps are implemented by the CPU 111 executing the units read from the external storage device 114 onto the RAM 113.

First, in S701, when the extended application 204 receives an advanced settings display request, the extended application 204 advances the process to S702.

In S702, the scan settings screen extension unit 205 of the extended application 204 causes the display unit 119 to display the advanced settings screen. The advanced settings screen is a setting screen in which a preview setting and a cropping setting (a preview setting and a masking setting in the case of the example of FIG. 5B) are added to the scan function information 203 by the scan function extension unit 206, as described with reference to FIG. 4. The scan settings screen extension unit 205 consults the scan capabilities generated based on the scan function information 203 to which these settings are added, and causes the display unit 119 to display the advanced settings screen as shown in FIG. 3C (or FIG. 3E in the case of the example of FIG. 5B).

Subsequently, in S703, the scan settings screen extension unit 205 determines whether there is any function setting from the user. Here, when there is a function setting from the user (when the determination is affirmative in S703), the scan settings screen extension unit 205 advances the process to S704.

In S704, the scan settings screen extension unit 205 receives advanced settings from the user, causes the CPU 111 to store the received settings in the RAM 113, and advances the process to S705.

On the other hand, when there is no function setting from the user (when the determination is negative in S703), the scan settings screen extension unit 205 directly advances the process to S705.

In S705, the scan settings screen extension unit 205 determines whether there is a preview display request from the user. Here, when there is no preview display request (when the determination is negative in S705), the scan settings screen extension unit 205 advances the process to S706.

On the other hand, when there is a preview display request (when the determination is affirmative in S705), the scan settings screen extension unit 205 advances the process to S713.

In S713, the extended application 204 creates a preview scan instruction command based on the setting information stored in S704. A method of creating a preview scan instruction command in S713, as well as a method for a scan instruction command, is, first, a method of extending the commands of a standard protocol. Examples of the extension method include a method of writing a command dedicated to an extended region of the commands of the standard protocol, a method of adding a unique standard command to the final position of the commands of the standard protocol, and a method of overwriting the commands of the standard protocol with a unique command system by the extended application 204.

When instructions are provided from the extended application 204, instructions and communications may be performed with a protocol unique to a vendor regardless of the standard protocol.

Subsequently, in S714, the extended application 204 sends the preview scan instruction command created in S713 to the scan apparatus 102 to provide scan instructions.

Subsequently, in S715, the extended application 204 determines whether the entire preview image data has been received from the scan apparatus 102. Here, when there is still part of the preview image data not yet received from the scan apparatus 102 (when the determination is negative in S715), the extended application 204 performs the determination of S715 again.

On the other hand, when the entire preview image data has been received from the scan apparatus 102 (when the determination is affirmative in S715), the extended application 204 advances the process to S716.

In S716, the extended application 204 displays the received preview image data in the preview image display region 308 and advances the process to S706.

In S706, the scan settings screen extension unit 205 determines whether there are setting end instructions from the user. Here, when there are no setting end instructions (when the determination is negative in S706), the scan settings screen extension unit 205 advances the process to S703.

On the other hand, when there are setting end instructions (when the determination is affirmative in S706), the scan settings screen extension unit 205 receives that the advanced settings are complete, writes the received settings to the scan settings information, and advances the process to S707.

In S707, the extended application 204 transmits, to the general-purpose scan software 202, that the advanced settings are complete.

Subsequently, in S708, the extended application 204 determines whether there are scan instructions from the general-purpose scan software 202. Here, when there are no scan instructions (when the determination is negative in S708), the extended application 204 performs the determination of S708 again.

On the other hand, when there are scan instructions (when the determination is affirmative in S708), the extended application 204 advances the process to S709 again.

In S709, the extended application 204 creates a scan instruction command based on the scan settings information written in S704. As a method of creating a scan instruction command in S709, first, there is a method of extending the commands of the standard protocol. As the extension method, there is a method of writing a command dedicated to the extended region of the commands of the standard protocol. Furthermore, there are a method of adding a unique standard command to the final position of the commands of the standard protocol, a method of overwriting the commands of the standard protocol with a unique command system by the extended application 204, and the like.

When instructions are provided from the extended application 204, instructions and communications may be performed with a protocol unique to a vendor regardless of the standard protocol.

Subsequently, in S710, the extended application 204 sends the scan instruction command created in S709 to the scan apparatus 102 to provide scan instructions.

Subsequently, in S711, the extended application 204 determines whether the entire image data has been received from the scan apparatus 102. Here, when there is still part of the image data not yet received from the scan apparatus 102 (when the determination is negative in S711), the extended application 204 performs the determination of S711 again.

On the other hand, when the entire image data has been received from the scan apparatus 102 (when the determination is affirmative in S711), the extended application 204 advances the process to S712.

In S712, the extended application 204 transmits the received image data to the general-purpose scan software 202 and ends the process of the flowchart.

The preview image may be configured to be discarded after the completion of advanced settings is received in S608 or when the advanced settings are cancelled, or may be configured to be held until final image data is acquired for the purpose of displaying the image data again when advanced settings are received again.

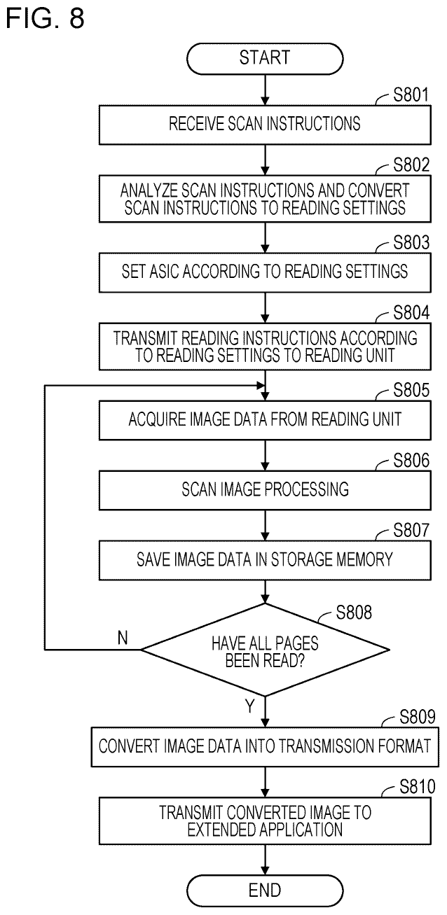

Next, the flow of the scan process of the scan apparatus 102 that has received scan instructions from the extended application 204 will be described with reference to FIG. 8.

FIG. 8 is a flowchart that shows an example of the scan process of the scan apparatus 102 that has received scan instructions from the extended application 204. Operations (steps) shown in the flowchart of FIG. 8 are implemented by the CPU 191 running a program stored in the ROM 192.

When the CPU 191 receives scan instructions transmitted from the extended application 204 in S801, the CPU 191 advances the process to S802.

In S802, the CPU 191 analyzes the scan instruction command received in S801 and converts the scan instruction command to reading settings that allow the scan apparatus 102 to perform reading.

For example, when the cropping setting is designated on the setting screen as shown in FIG. 3C in S613 of FIG. 6, the cropping setting designated in S613 is set in the reading settings. When the reading size is not designated, the reading size is set to, for example, the default setting A4H size. When the scan apparatus 102 has the capability to freely set the reading size, a cropping setting may be configured to be set as the reading size. In this case, it is possible to read only part of a region used from the beginning, so cropping is not used.

In another example, when the masking setting is designated on the setting screen as shown in FIG. 3E in S613 of FIG. 6, the masking setting designated in S613 is set in the reading settings. When the reading size is not designated, the reading size is set to, for example, the default setting A4H size.

Subsequently, in S803, the CPU 191 determines the ASIC of the image processing unit 190, used to perform a scan, based on the reading settings converted in S802 and configures settings of the ASIC.

Subsequently, in S804, the CPU 191 transmits reading instructions according to the reading settings to the reading unit 195.

When, for example, the “reading size: A4H” and the cropping setting on the platen glass are designated in S613 of FIG. 6, the CPU 191 transmits instructions to perform reading while the “reading size: A4H” and the cropping setting on the platen glass are set as the region designated in S613 of FIG. 6. For reading of a plurality of pages, the cropping setting associated with the page number currently intended to be set is applied.

In another example, when the “reading size: A4H” and the masking setting on the platen glass are designated in S613 of FIG. 6, the CPU 191 transmits instructions to perform reading while the “reading size: A4H” and the masking setting on the platen glass are set as the region designated in S613 of FIG. 6. For reading of a plurality of pages, the masking setting associated with the page number currently intended to be set is applied.

In S805, the CPU 191 acquires image data of A4H size from the reading unit 195.

In S806, the CPU 191 and the image processing unit 190 execute image processing on the received image data. In the case of the example in which the cropping setting is applied, cropping is performed in the designated region of the image data. In the case of the example in which the masking setting is applied, masking is performed in the designated region of the image data.

In S807, the CPU 191 saves the image data subjected to image processing in S806 in the external storage device 199.

Subsequently, in S808, the CPU 191 determines whether the scan process for all the pages is complete. Here, when the CPU 191 determines that there are still pages for which the scan process is not complete (when the determination is negative in S808), the CPU 191 returns the process to S805 and executes control such that the scan process for the next page is executed.

On the other hand, when the CPU 191 determines that the scan process for all the pages is already complete (when the determination is affirmative in S808), the CPU 191 advances the process to S809.

In S809, the CPU 191 and the image processing unit 190 convert the image data saved in S807 in accordance with the transmission format setting received in S801. In the present embodiment, since the transmission format is not included in the scan instructions received from the extended application 204, the image data is converted to the default JPEG format of the scan apparatus 102.

However, the transmission format used for conversion is not limited thereto, and any transmission format is applicable as long as the transmission format can be handled in the information processing apparatus.

In S810, the CPU 191 transmits the image data converted in S809 to the extended application 204 and ends the process of the flowchart. A transmission destination for the image data may be the scan application 201 or the general-purpose scan software 202 (see a third embodiment (described later) for an example in which the image data is output to the general-purpose scan software 202).

An output destination for the image data from the scan apparatus 102 in S810 is not limited to the host computer 101. The image data may be transmitted to a terminal, a multifunction peripheral, or the like, different from the host computer 101 from which scan instructions are provided, using, for example, email, chat application, or fax. The transmission destination may be received through input on the advanced settings screen or set by consulting the address book of the host computer 101.

The flow of the scan process has been described with reference to FIG. 8, and a preview scan process is also the same. However, in the case of a preview scan, additional image conversion for preview display may be configured to be performed as described above. For example, when instructions for a preview scan are provided, some of the scan instruction contents may be ignored in S802 and a lower resolution within the resolutions supported by the scan apparatus 102 may be set, or a higher compression ratio may be set. Alternatively, those conversions may be performed in S809.

As described above, in the present embodiment, the scan settings screen extension unit 205 of the extended application 204 corrects the scan function information 203 based on the capability information of the general-purpose scan software 202, the extended application 204, and the scan apparatus 102. When the user requests the advanced settings screen, the settings screen is displayed based on the scan capabilities generated from the scan function information 203, with the result that it is possible to receive preview display, and a cropping setting or a masking setting from the user. After that, the scan apparatus 102 performs a preview scan based on preview scan instructions, and the extended application 204 displays a preview image and allows the user to perform a cropping setting or a masking setting.

After that, when the scan apparatus 102 receives scan instructions that reflect, for example, the cropping setting, the scan apparatus 102 reads a document and cuts out a designated region in cropping. Through the above series of processes, the scan apparatus 102 can implement the cropping function, so it is possible to provide the user with the cropping setting function.

When the scan apparatus 102 receives scan instructions that reflect the masking setting, the scan apparatus 102 reads a document and fills in a designated region in masking. Through the above series of processing, the scan apparatus 102 can implement the masking function, so it is possible to provide the user with the masking setting function.

In the present embodiment, the description has been made by using the advanced settings screen as shown in FIGS. 3C and 3E under the configuration of FIG. 2B; however, the present disclosure is not limited thereto. For example, when an advanced settings display request is issued to the general-purpose scan software 202 in S604, the general-purpose scan software 202 may display the advanced settings screen shown in FIG. 3B. Subsequently, after the completion of the advanced settings of FIG. 3B, the general-purpose scan software 202 requests the extended application 204 to display an additional advanced settings screen. In response to this request, the extended application 204 may additionally display an advanced settings screen that allows preview and a cropping setting or masking setting.

The scan instructions to the extended application 204 are configured to be provided from the general-purpose scan software 202; however, the configuration is not limited thereto. Scan instructions to the extended application 204 may be a method of providing instructions from the scan application 201 to the extended application 204 or a control for scan instructions is disposed on the advanced settings screen and the user directly provides instructions to the extended application 204. A method of transferring image data may be a method of transferring directly from the extended application 204 to the scan application 201 without intervening the general-purpose scan software 202 or a method of transferring from the scan apparatus 102 to the scan application 201. Received image data may be saved in the external storage device 114, and only information about a file path that is a save destination may be transferred.

In the present embodiment, when there are multiple pieces of image data, a method in which all the pieces of image data are received and then are transferred is applied. Alternatively, image data may be transferred each time the image data is received.

In the above embodiment, the configuration that the cropping setting and the masking setting are allowed has been described. Alternatively, the cropping setting and the masking setting may also be simultaneously settable. In other words, it is also applicable that both the cropping setting for cropping a designated cropping region and the masking setting for masking a designated masking region are simultaneously settable, and this also applies to embodiments that will be described below.

### Second Embodiment

In the first embodiment, the scan apparatus 102 interprets the scan settings information including the cropping setting or the masking setting, and the scan apparatus 102 performs a scan process with the designated cropping function or masking function. Depending on the scan apparatus, cropping or masking can be possibly not supported in consideration of cost and the like. In this case, even when the extended application supports a cropping setting or a masking setting and can generate scan settings information including the cropping setting or the masking setting, the scan apparatus cannot perform cropping or masking.

In the second embodiment, first, it is determined whether a cropping setting, a masking setting, or the like is possible based on the capability information of the scan apparatus. Subsequently, for example, for a cropping setting, when the scan apparatus is capable of performing cropping, scan settings information including a cropping setting, designated by the user, is generated and transferred to the scan apparatus. On the other hand, when the scan apparatus does not support cropping, scan settings information not including a cropping setting of scan settings designated by the user is generated and transferred to the scan apparatus, and image data read by the scan apparatus is subjected to cropping with the extended application. In other words, when the received cropping setting is not a setting that can be executed by the image reading apparatus that performs a scan, cropping is performed by the extended application on an image read by the image reading apparatus. For a masking setting, when the scan apparatus is capable of performing masking, scan settings information including a masking setting function, designated by the user, is generated and transferred to the scan apparatus. On the other hand, when the scan apparatus does not support masking, scan settings information not including a masking setting of scan settings designated by the user is generated and transferred to the scan apparatus, and image data read by the scan apparatus is subjected to masking with the extended application.

In other words, when the received masking setting is not a setting that can be executed by the image reading apparatus that performs a scan, masking is performed by the extended application on an image read by the image reading apparatus. Thus, even when the scan apparatus does not support the cropping function or the masking function, it is possible to provide the cropping setting function or the masking setting function with the user.

Hereinafter, only the differences from the first embodiment will be described.

### When Scan Apparatus 102 Does Not Support Cropping Function

First, the case where the scan apparatus 102 is a scan apparatus that supports a preview function but does not support a cropping function will be described as an example.

The configuration of the extended application 204 according to the present embodiment differs from the configuration of the extended application 204 according to the first embodiment. The scan function extension unit 206, different from the first embodiment, checks whether there is a unit for cropping image data in the extended application 204 even when there is no cropping function in the capability information acquired from the scan apparatus 102. When there is the unit, the scan function extension unit 206 adds the cropping setting to the scan function information 203. The image data editing unit 207 performs cropping on the image data received from the scan apparatus 102 based on the cropping setting set by the user. The details will be described later.

### Flowchart of Scan Function Extension Unit 206 That Edits Scan Function Information 203 according to Second Embodiment

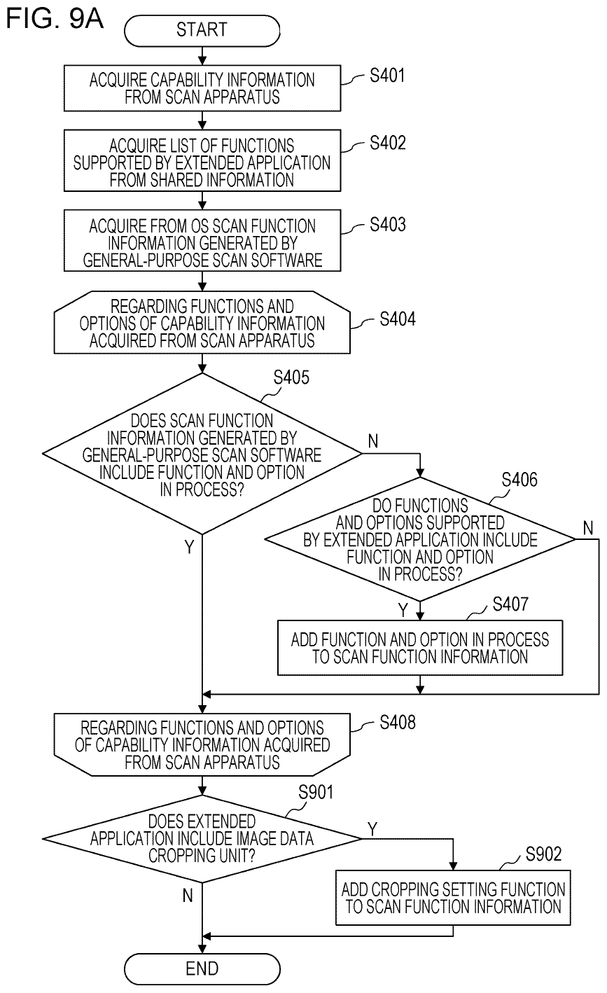

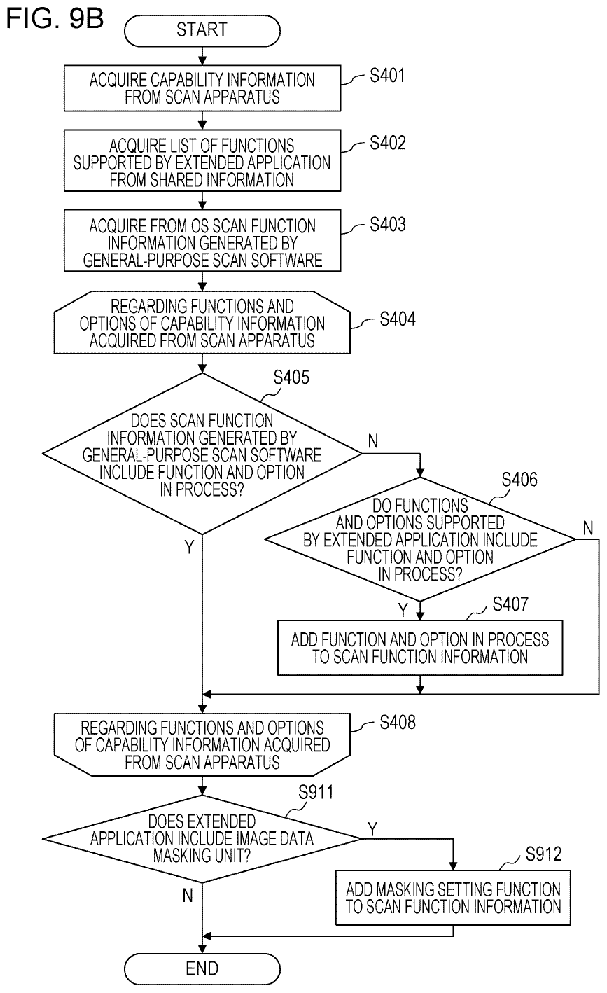

Hereinafter, a scan function information editing process executed by the scan function extension unit 206 in the second embodiment will be described with reference to FIG. 9A. Particularly, the case where the scan apparatus 102 does not support the cropping function will be described.

FIG. 9A is a flowchart that shows an example of the scan function information editing process executed by the scan function extension unit 206 in the second embodiment. Steps of FIG. 9A are implemented by the CPU 111 executing the units read from the external storage device 114 onto the RAM 113. Like step numbers are assigned to the same steps as those of FIG. 4.

When the scan function extension unit 206 completes the repeated processing of S404 to S406, the scan function extension unit 206 advances the process to S901. Here, it is assumed that the scan apparatus 102 does not support the cropping function. Therefore, the cropping function is not added to the scan function information 203 after the completion of the processing of S404 to S406. Therefore, in S901 and S902, a process of adding functions to the scan function information 203 is executed in accordance with the modules of the extended application 204, which are not included in the capability information returned from the scan apparatus 102. Hereinafter, the description will be specifically made.

Here, although not shown in the drawing since the case where the scan apparatus 102 does not support the cropping function is being described, when the cropping function is present in the scan function information 203 after the completion of the processing of S404 to S406, the scan function extension unit 206 skips the processing of S901 and S902 described below.

In S901, the scan function extension unit 206 consults Table 502 in FIG. 5A and the scan function information 203 and determines whether the extended application 204 includes a module for cropping.

Here, when the extended application 204 includes a module for cropping (when the determination is affirmative in S901), the scan function extension unit 206 advances the process to S902.

In S902, the scan function extension unit 206 adds the cropping function to the scan function information 203 and ends the process of the flowchart.

On the other hand, when the extended application 204 includes no module for cropping (when the determination is negative in S901), the scan function extension unit 206 directly ends the process of the flowchart.

As described above, the scan function extension unit 206 adds a function and option that is not supported by the general-purpose scan software 202 but supported by the scan apparatus 102 and the extended application 204 to the scan function information 203. After that, the scan function extension unit 206 determines whether the extended application 204 can perform cropping on image data. When the extended application 204 can perform cropping, the scan function extension unit 206 adds the cropping function to the scan function information 203. With this process, even when the scan apparatus 102 does not support the cropping function, the scan settings screen extension unit 205 generates a display screen based on the scan capabilities generated from the scan function information 203, with the result that it is possible to display the advanced settings screen as shown in FIGS. 3B to 3H.

### When Scan Apparatus 102 Does Not Support Masking Function

Next, the case where the scan apparatus 102 is a scan apparatus that supports a preview function but does not support a masking function will be described. The scan function extension unit 206 according to the second embodiment, different from the first embodiment, checks whether there is a unit for masking image data in the extended application 204 even when there is no masking function in the capability information acquired from the scan apparatus 102. When there is the unit, the scan function extension unit 206 adds the masking setting to the scan function information 203. The image data editing unit 207 performs masking on the image data received from the scan apparatus 102 based on the masking setting set by the user. The details will be described later.

### Another Example of Flowchart of Scan Function Extension Unit 206 That Edits Scan Function Information 203 according to Second Embodiment

Another example of the scan function information editing process executed by the scan function extension unit 206 in the second embodiment will be described with reference to FIG. 9B. Particularly, the case where the scan apparatus 102 does not support the masking function will be described.

FIG. 9B is a flowchart that shows another example of the scan function information editing process executed by the scan function extension unit 206 in the second embodiment. Steps of FIG. 9B are implemented by the CPU 111 executing the units read from the external storage device 114 onto the RAM 113. Like step numbers are assigned to the same steps as those of FIG. 4.

When the scan function extension unit 206 completes the repeated processing of S404 to S406, the scan function extension unit 206 advances the process to S911. Here, it is assumed that the scan apparatus 102 does not support the masking function. Therefore, the masking function is not added to the scan function information 203 after the completion of the processing of S404 to S406. Therefore, in S911 and S912, a process of adding functions to the scan function information 203 is executed in accordance with the modules of the extended application 204, which are not included in the capability information returned from the scan apparatus 102. Hereinafter, the description will be specifically made.

Although not shown in the drawing since the case where the scan apparatus 102 does not support the masking function is being described, when the masking function is present in the scan function information 203 after the completion of the processing of S404 to S406, the scan function extension unit 206 skips the processing of S911 and S912 described below.

In S911, the scan function extension unit 206 consults Table 502 in FIG. 5B and the scan function information 203 and determines whether the extended application 204 includes a module for masking.

Here, when the extended application 204 includes a module for masking (when the determination is affirmative in S911), the scan function extension unit 206 advances the process to S912.

In S912, the scan function extension unit 206 adds the masking function to the scan function information 203 and ends the process of the flowchart.

On the other hand, when the extended application 204 includes no module for masking (when the determination is negative in S911), the scan function extension unit 206 directly ends the process of the flowchart.

A configuration that combines FIG. 9A and FIG. 9B with each other is applicable. In other words, the processing of S911 and S912 in FIG. 9B may be executed after the processing of S901 and S902 in FIG. 9A.

As described above, the scan function extension unit 206 adds a function and option that is not supported by the general-purpose scan software 202 but supported by the scan apparatus 102 and the extended application 204 to the scan function information 203. After that, the scan function extension unit 206 determines whether the extended application 204 can perform cropping or masking on image data. When the extended application 204 can perform cropping, the scan function extension unit 206 adds the cropping function to the scan function information 203. When the extended application 204 can perform masking, the scan function extension unit 206 adds the masking function to the scan function information 203. With this process, even when the scan apparatus 102 does not support the cropping function or the masking function, the scan settings screen extension unit 205 generates a display screen based on the scan capabilities generated from the scan function information 203, with the result that it is possible to display the advanced settings screen as shown in FIGS. 3B to 3H.

### Sequence After Scan Application 201 Receives Scan Settings in Second Embodiment

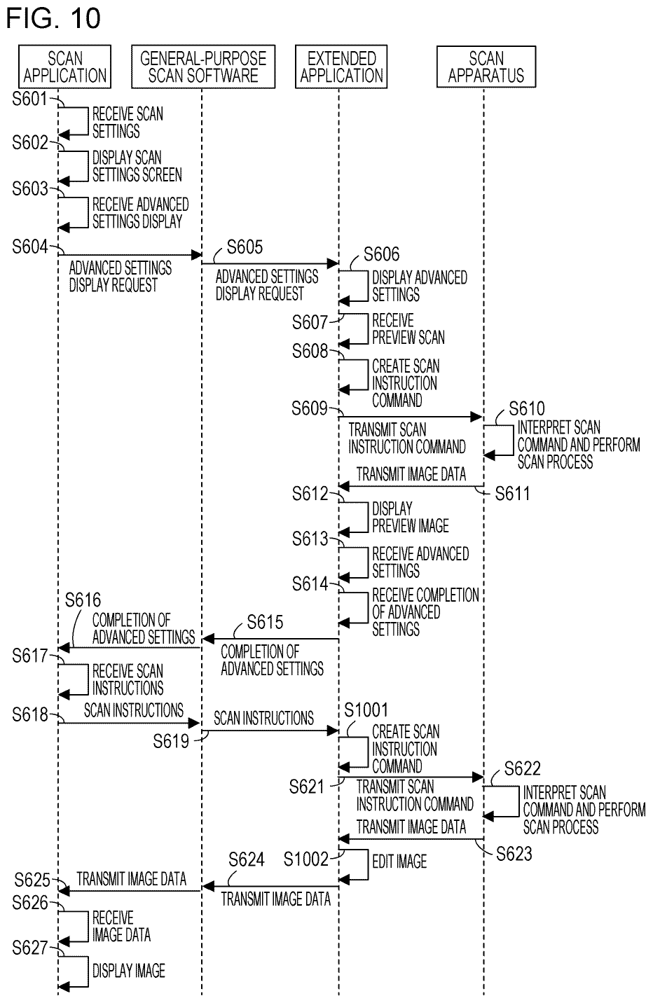

Next, the sequence of the scan application 201, the general-purpose scan software 202, the extended application 204, and the scan apparatus 102 after the scan application 201 receives scan settings will be described with reference to FIG. 10.

FIG. 10 is a diagram that illustrates the sequence of the scan application 201, the general-purpose scan software 202, the extended application 204, and the scan apparatus 102 after the scan application 201 receives scan settings in the second embodiment. Steps other than steps performed by the scan apparatus 102 in FIG. 10 are implemented by the CPU 111 reading the scan application 201, the general-purpose scan software 202, and the extended application 204 from the external storage device 114 onto the RAM 113 and launching the software. Steps performed by the scan apparatus 102 in FIG. 10 are implemented by the CPU 191 of the scan apparatus 102 reading a program stored in the ROM 192 or the external storage device 199 onto the RAM 193 and running the program. Like step numbers are assigned to the same steps as those of FIG. 6.

When the extended application 204 of the second embodiment receives scan instructions from the general-purpose scan software 202 in S619, the extended application 204 executes the processing of S1001.

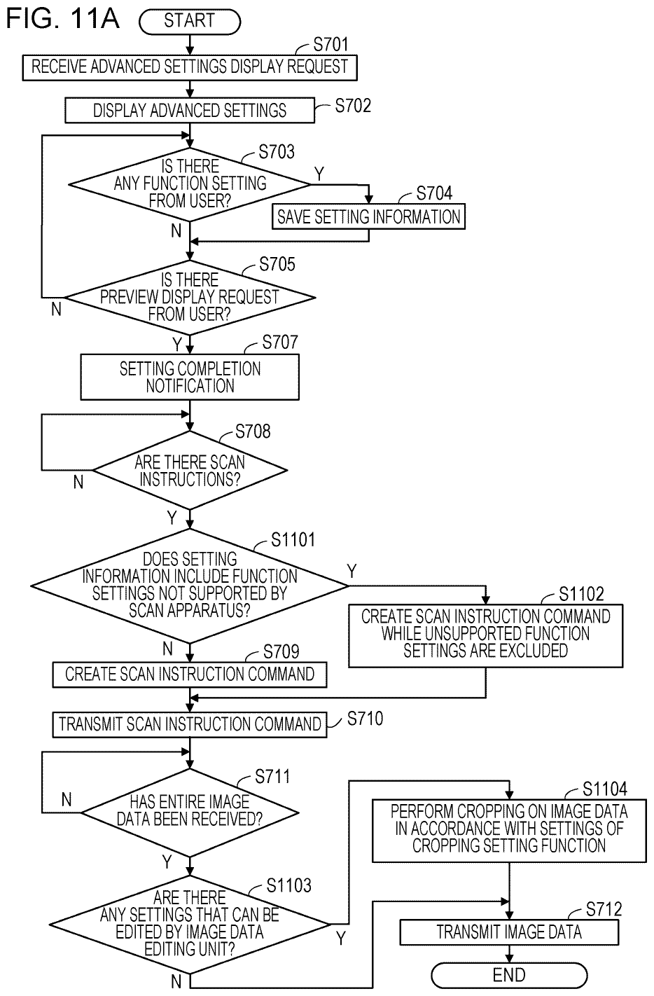

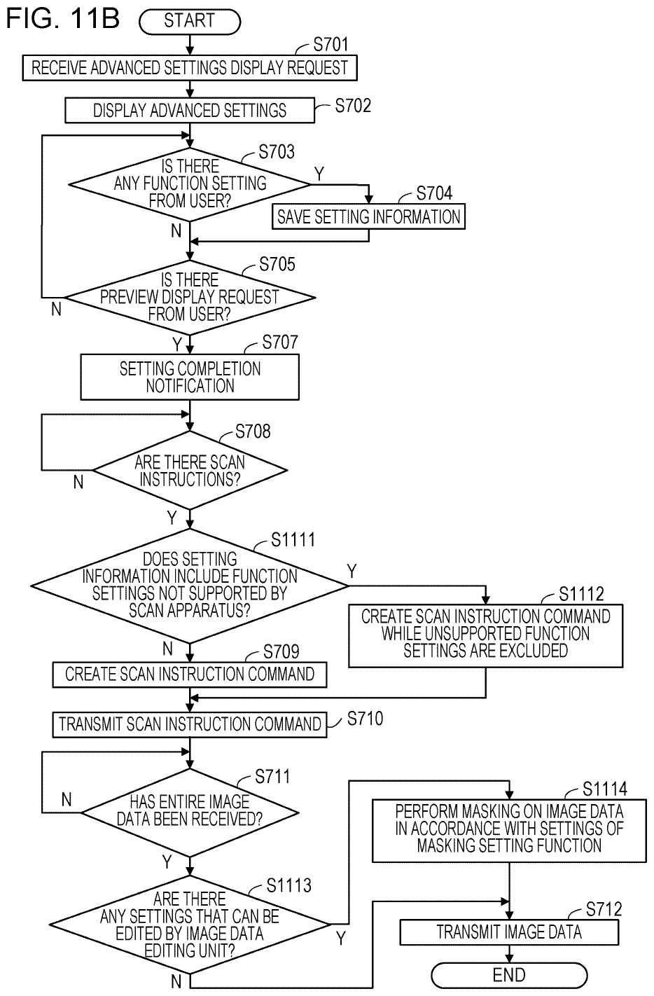

In S1001, the extended application 204 creates a reading instruction command. The details of this process will be described with reference to the flowchart of FIG. 11A or FIG. 11B.

The extended application 204 of the second embodiment executes the processing of S1002 when receiving image data from the scan apparatus 102.

In S1002, the image data editing unit 207 of the extended application 204 executes image edit on the image data received from the scan apparatus 102. When, for example, the cropping setting is performed on the setting screen as shown in FIG. 3C in S613, the image data editing unit 207 crops the image data in the designated region and creates different image data. When the masking setting is performed on the setting screen as shown in FIG. 3E in S613, the image data editing unit 207 masks the image data in the designated region and creates different image data.

### When Extended Application 204 Executes Cropping

Here, the flow in which extended application 204 executes cropping will be described with reference to FIG. 11A.

FIG. 11A is a flowchart that illustrates an example of the scan process executed by the extended application 204 in the second embodiment. Steps are implemented by the CPU 111 executing the units read from the external storage device 114 onto the RAM 113. Like step numbers are assigned to the same steps as those of FIG. 7.

When the extended application 204 of the second embodiment receives scan instructions from the general-purpose scan software 202 (when the determination is affirmative in S708), the extended application 204 advances the process to S1101.

In S1101, the extended application 204 acquires the capability information of the scan apparatus 102 from the shared information 208. When there is no capability information of the scan apparatus 102, the scan function extension unit 206 may request the capability information from the scan apparatus 102 and save the capability information in the shared information 208. Then, the extended application 204 determines whether there are any function settings (here, described as a cropping setting) not supported by the scan apparatus 102, based on the acquired capability information and setting information.

Here, when there are function settings not supported by the scan apparatus 102 in the setting information (when the determination is affirmative in S1101), the extended application 204 advances the process to S1102.

In S1102, the extended application 204 performs settings excluding the function settings (here, cropping setting) not supported by the scan apparatus 102 to create a reading instruction command and advances the process to S710.

On the other hand, when there are no function settings not supported by the scan apparatus 102 in the setting information (when the determination is negative in S1101), the extended application 204 advances the process to S709.

When the extended application 204 of the second embodiment receives the entire image data from the scan apparatus 102 (when the determination is affirmative in S711), the extended application 204 advances the process to S1103.

In S1103, the extended application 204 determines whether there are any settings that can be edited in the image data editing unit 207, based on the setting information.

Here, when functions (in this case, the cropping function) not supported by the scan apparatus 102 are set, the extended application 204 determines that there are settings that can be edited in the image data editing unit 207 (when the determination is affirmative in S1103) and advances the process to S1104.

In S1104, the image data editing unit 207 performs cropping on the received image data based on the cropping setting set in S704 and advances the process to S712.

On the other hand, when there are no settings that can be edited in the image data editing unit 207 (when the determination is negative in S1103), the extended application 204 directly advances the process to S712.

As described above, in the second embodiment, even when the scan apparatus does not support the cropping function, it is possible to provide the user with the cropping setting function.

### When Extended Application 204 Executes Masking

Here, the flow in which the extended application 204 executes masking will be described with reference to FIG. 11B.

FIG. 11B is a flowchart that illustrates another example of the scan process executed by the extended application 204 in the second embodiment. Steps are implemented by the CPU 111 executing the units read from the external storage device 114 onto the RAM 113. Like step numbers are assigned to the same steps as those of FIG. 7.

When the extended application 204 of the second embodiment receives scan instructions from the general-purpose scan software 202 (when the determination is affirmative in S708), the extended application 204 advances the process to S1111.

In S1111, the extended application 204 acquires the capability information of the scan apparatus 102 from the shared information 208. Then, the extended application 204 determines whether there are any function settings (here, described as a masking setting) not supported by the scan apparatus 102, based on the acquired capability information and setting information.

Here, when there are function settings not supported by the scan apparatus 102 in the setting information (when the determination is affirmative in S1111), the extended application 204 advances the process to S1112.

In S1112, the extended application 204 performs settings excluding the function settings (here, masking setting) not supported by the scan apparatus 102 to create a reading instruction command and advances the process to S710.

On the other hand, when there are no function settings not supported by the scan apparatus 102 in the setting information (when the determination is negative in S1111), the extended application 204 advances the process to S709.

When the extended application 204 of the second embodiment receives the entire image data from the scan apparatus 102 (when the determination is affirmative in S711), the extended application 204 advances the process to S1113.

In S1113, the extended application 204 determines whether there are any settings that can be edited in the image data editing unit 207, based on the setting information.

Here, when functions (in this case, the masking function) not supported by the scan apparatus 102 are set, the extended application 204 determines that there are settings that can be edited in the image data editing unit 207 (when the determination is affirmative in S1113) and advances the process to S1114.

In S1114, the image data editing unit 207 performs masking on the received image data based on the masking setting set in S703 and S704 and advances the process to S712.

On the other hand, when there are no settings that can be edited in the image data editing unit 207 (when the determination is negative in S1113), the extended application 204 directly advances the process to S712.

As described above, in the second embodiment, even when the scan apparatus does not support the masking function, it is possible to provide the user with the masking setting function.

### Third Embodiment

In the first and second embodiments, the extended application 204 and the scan apparatus 102 are configured to exchange data with each other.

In the third embodiment, the configuration in which the general-purpose scan software 202 exchanges data with the scan apparatus 102 and the extended application 204 is configured to perform only extension of a scan command and image edit will be described. Hereinafter, only the differences from the first and second embodiments will be described.

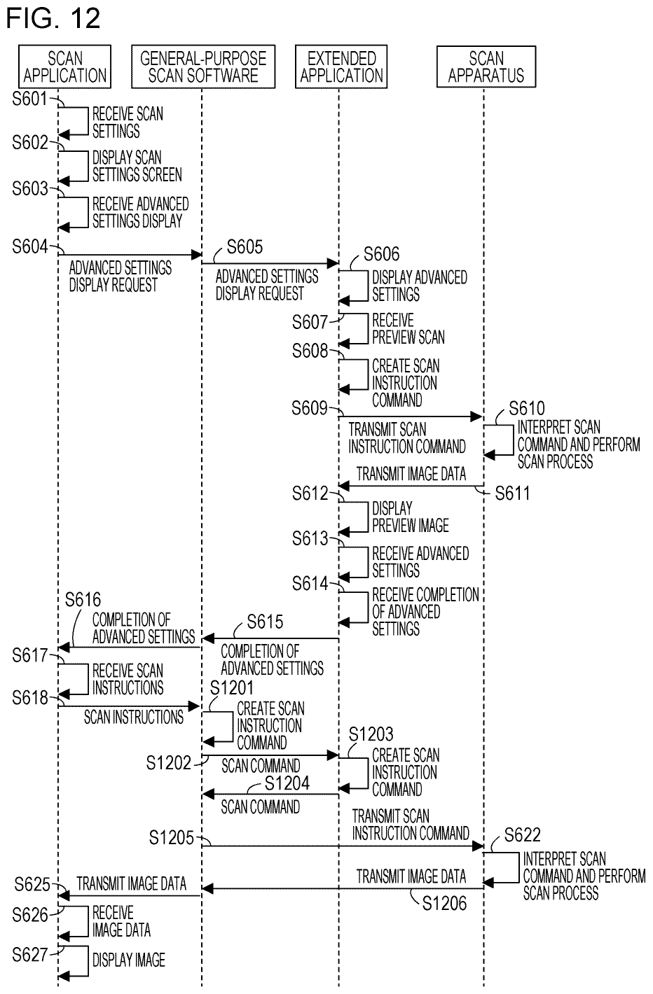

The sequence of the scan application 201, the general-purpose scan software 202, the extended application 204, and the scan apparatus 102 after the scan application 201 receives scan settings will be described with reference to FIG. 12.

FIG. 12 is a diagram that illustrates the sequence of the scan application 201, the general-purpose scan software 202, the extended application 204, and the scan apparatus 102 after the scan application 201 receives scan settings in the third embodiment. Steps other than steps performed by the scan apparatus 102 in FIG. 12 are implemented by the CPU 111 reading the scan application 201, the general-purpose scan software 202, and the extended application 204 from the external storage device 114 onto the RAM 113 and launching the software. Steps performed by the scan apparatus 102 in FIG. 12 are implemented by the CPU 191 of the scan apparatus 102 reading a program stored in the ROM 192 or the external storage device 199 onto the RAM 193 and running the program. Like step numbers are assigned to the same steps as those of FIG. 6.

The scan application 201 of the third embodiment provides scan instructions to the general-purpose scan software 202. When the general-purpose scan software 202 receives scan instructions from the scan application 201 in S618, the general-purpose scan software 202 executes the processing of S1201.

In S1201, the general-purpose scan software 202 creates a scan instruction command. At this time, the general-purpose scan software 202 does not create a scan instruction command for functions not supported by the general-purpose scan software 202.

Subsequently, in S1202, the general-purpose scan software 202 passes the scan instruction command created in S1201 to the extended application 204. The extended application 204 executes the processing of S1203 when receiving the scan instruction command.

In S1203, the extended application 204 adds an additional instruction command for functions not supported by the general-purpose scan software 202 and makes changes to the existing instructions for the received scan instruction command and extends the command (creates a scan instruction command). When, for example, the scan settings received from the user in S613 include the cropping setting but the scan instruction command created by the general-purpose scan software 202 in S1201 does not include the cropping setting, the cropping setting is added here. When the scan settings received from the user in S613 include the masking setting but the scan instruction command created by the general-purpose scan software 202 in S1201 does not include the masking setting, the masking setting is added here.

Subsequently, in S1204, the extended application 204 passes the scan instruction command extended in S1203 to the general-purpose scan software 202. The general-purpose scan software 202 executes the processing of S1205 when receiving the scan instruction command.

In S1205, the general-purpose scan software 202 transmits the received scan instruction command to the scan apparatus 102 to provide scan instructions. The scan apparatus 102 executes the processing of S622 when receiving the scan instruction command.

In S622, the scan apparatus 102 interprets the scan instruction command to perform a scan.

In S1206, the scan apparatus 102 transmits the image data generated by the scan in S622 to the general-purpose scan software 202. The general-purpose scan software 202 executes the processing of S625 when receiving the image data from the scan apparatus 102.

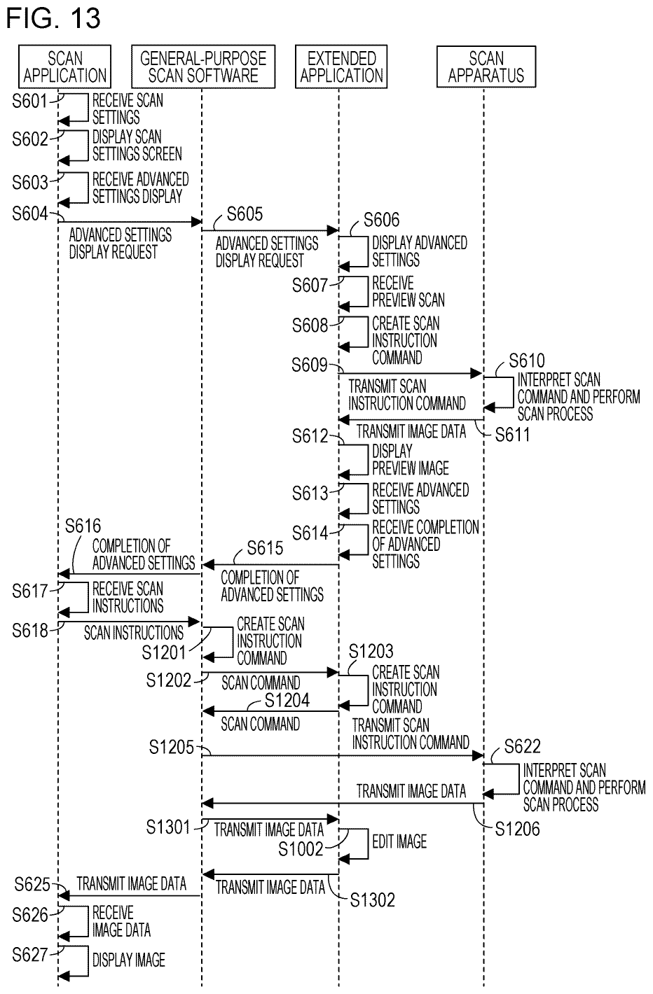

Subsequently, in another example, the sequence in the case where the extended application 204 performs image edit, such as cropping and masking, when the general-purpose scan software 202 and the scan apparatus 102 exchange data with each other will be described with reference to FIG. 13.

FIG. 13 is a diagram that illustrates the sequence in the case where the extended application 204 performs image edit when the general-purpose scan software 202 and the scan apparatus 102 exchange data with each other in the third embodiment. Steps other than steps performed by the scan apparatus 102 in FIG. 13 are implemented by the CPU 111 reading the scan application 201, the general-purpose scan software 202, and the extended application 204 from the external storage device 114 onto the RAM 113 and launching the software. Steps performed by the scan apparatus 102 in FIG. 13 are implemented by the CPU 191 of the scan apparatus 102 reading a program stored in the ROM 192 or the external storage device 199 onto the RAM 193 and running the program. Like step numbers are assigned to the same steps as those of FIGS. 10 and 12.

When the extended application 204 performs image edit, the general-purpose scan software 202 executes the processing of S1301 when receiving the image data from the scan apparatus 102 in S1206.

In S1301, the general-purpose scan software 202 transmits the image data received in S1206 to the extended application 204. The extended application 204 executes the processing of S1002 when receiving the image data.

In S1002, the extended application 204 performs image edit. For example, when the cropping setting is applied, cropping is performed in processing similar to S1104 in FIG. 11A. When the masking setting is applied, masking is performed in processing similar to S1114 in FIG. 11B.

Subsequently, in S1302, the extended application 204 transmits the image data edited in S1002 to the general-purpose scan software 202.

As described above, in the present embodiment, the extended application 204 can implement the cropping setting function or the masking setting function for the scan apparatus 102 when the extended application 204 extends the reading instruction command, with the result that it is possible to provide the user with the cropping setting function or the masking setting function.

### Fourth Embodiment

In the first to third embodiments, the commands used in the standard protocol are extended to exchange data with the scan apparatus 102.

In the fourth embodiment, the configuration in which the commands of the standard protocol are not extended and functions supported by only the extended application 204 are exchanged with the scan apparatus 102 with separate commands will be described. Hereinafter, only the differences from the above-described embodiments will be described.

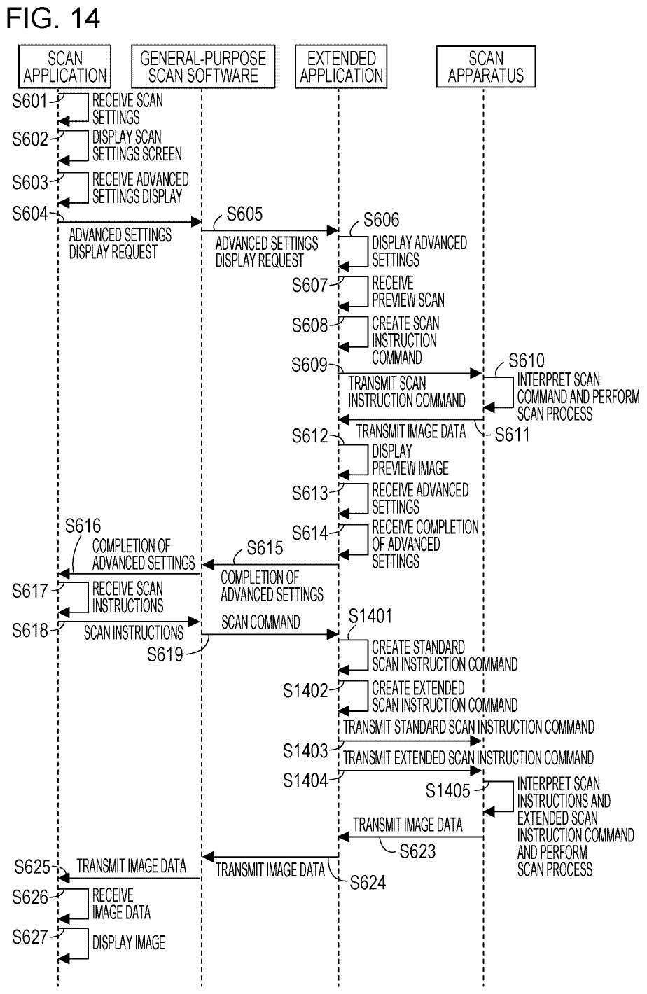

The sequence of the scan application 201, the general-purpose scan software 202, the extended application 204, and the scan apparatus 102 after the scan application 201 receives scan settings will be described with reference to FIG. 14.

FIG. 14 is a diagram that illustrates the sequence of the scan application 201, the general-purpose scan software 202, the extended application 204, and the scan apparatus 102 after the scan application 201 receives scan settings in the fourth embodiment. Steps other than steps performed by the scan apparatus 102 in FIG. 14 are implemented by the CPU 111 reading the scan application 201, the general-purpose scan software 202, and the extended application 204 from the external storage device 114 onto the RAM 113 and launching the software. Steps performed by the scan apparatus 102 in FIG. 14 are implemented by the CPU 191 of the scan apparatus 102 reading a program stored in the ROM 192 or the external storage device 199 onto the RAM 193 and running the program. Like step numbers are assigned to the same steps as those of FIG. 6.

When the extended application 204 of the fourth embodiment receives scan instructions from the general-purpose scan software 202 in S619, the extended application 204 executes the processing of S1401.

In S1401, the general-purpose scan software 202 creates a standard scan instruction command according to the standard protocol. At this time, the general-purpose scan software 202 does not create a scan instruction command for functions not supported by the standard protocol.

In S1402, the extended application 204 creates an extended scan instruction command for functions supported by only the extended application 204. For example, cropping or masking is written in the extended scan instruction command.

Subsequently, in S1403, the extended application 204 transmits the standard scan instruction command to the scan apparatus 102.

In S1404, the extended application 204 transmits the extended scan instruction command to the scan apparatus 102.

The scan apparatus 102 executes the processing of S1405 when receiving the standard scan instruction command and the extended scan instruction command from the extended application 204.

In S1405, the scan apparatus 102 interprets the received standard scan instruction command and extended scan instruction command to execute a scan process.

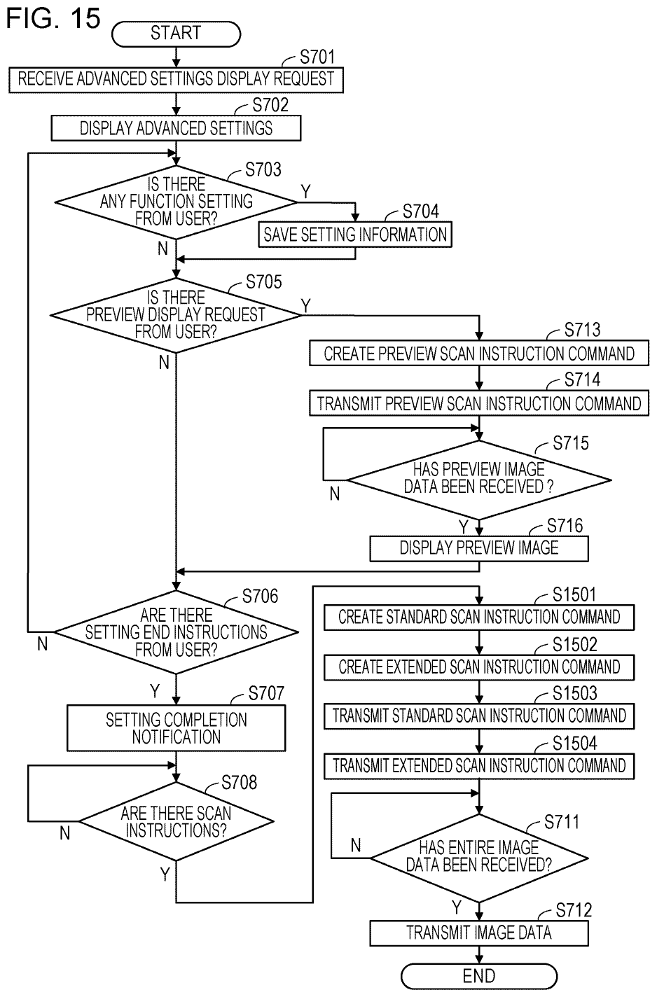

Here, the flow in which the extended application 204 executes a scan process will be described with reference to FIG. 15.

FIG. 15 is a flowchart that illustrates an example of the scan process executed by the extended application 204 in the fourth embodiment. Steps are implemented by the CPU 111 executing the units read from the external storage device 114 onto the RAM 113. Like step numbers are assigned to the same steps as those of FIG. 7.

When the extended application 204 of the fourth embodiment receives scan instructions from the general-purpose scan software 202 (when the determination is affirmative in S708), the extended application 204 advances the process to S1501.

In S1501, the extended application 204 creates a standard scan instruction command according to the standard protocol.

In S1502, the extended application 204 creates an extended scan instruction command for functions not supported by the standard protocol. For example, cropping or masking is written in the extended scan instruction command.

Subsequently, in S1503, the extended application 204 transmits the standard scan instruction command created in S1501 to the scan apparatus 102.

In S1504, the extended application 204 transmits the extended scan instruction command created in S1502 to the scan apparatus 102.

As described above, in the fourth embodiment, other scan instruction commands are transmitted from the extended application 204 for functions not supported by the standard protocol, with the result that it is possible to provide the user with the cropping setting function or the masking setting function.

### Fifth Embodiment

In the first embodiment, when the masking setting is performed, the user determines a masking region by setting the masking setting region 320. In the present embodiment, the configuration in which the masking region is determined automatically will be described. Hereinafter, only the differences from the first embodiment will be described. OCR processing used in the present embodiment is a known technology, so the detailed description thereof is omitted.

In the fifth embodiment, a setting button (not shown in FIG. 3E) is provided for providing instructions to whether to perform automatic masking region setting during a preview scan.

Automatic masking region setting is intended to, when, for example, a document containing personal information is scanned, identify regions containing information to be masked, such as date of birth and telephone number, with OCR and automatically determine the masking region.

It may be possible to individually designate which items to mask, such as date of birth, name, and telephone number, with checkboxes or to perform determination on predetermined items. The settings of the automatic masking region are stored in the RAM 113.

When a preview scan is performed while the automatic masking region setting is enabled, the extended application 204 under control of the CPU 111 performs OCR on the read image and determines regions that contain designated items before a preview image is displayed in S716 of FIG. 7. Then, the masking region is determined so as to include those regions. The masking region determined here may be multiple.

The determined masking region is displayed as the masking setting region 320 in the image to be displayed in the preview image display region 308 in S716.

After a preview scan is performed, when automatic masking region setting is enabled, the extended application 204 under control of the CPU 111 performs OCR on the preview image and determines regions that contain designated items. Then, the masking region is determined so as to include those regions. The masking region determined here may be multiple.

The determined masking region is displayed in the masking setting region 320.

After that, when a scan is performed, the scan apparatus 102 performs masking on the scanned image, as in the case of the first embodiment, based on the settings of the determined masking region.

Thus, the user is able to automatically set a masking region without manually setting a masking region, so time and effort can be reduced.

In the present embodiment, the configuration of the case where the extended application 204 has an OCR function has been described as an example. When the scan apparatus 102 has an OCR function, the scan apparatus 102 may perform OCR and determine a masking region. In this case, when the extended application 204 and the scan apparatus 102 support automatic masking region setting, a setting button for automatic masking region setting is displayed in FIG. 3E. When a preview scan is performed while the setting is enabled, the extended application 204 adds automatic masking region setting enabled and information about items to be masked to the preview scan instruction command. The scan apparatus 102 that has received the preview scan instruction command performs OCR on the scanned image with the CPU 191 to determine regions containing items to be masked. The scan apparatus 102 notifies the extended application 204 of the information about the determined masking region in addition to image data. The extended application 204 displays the masking setting region 320 on the preview image based on the received information about the masking region.

In the present embodiment, the configuration of the case where the result of a preview scan is subjected to OCR and a masking region is determined has been described as an example. Alternatively, the result of a scan may be subjected to OCR without a preview scan. In this case, the masking region determined through OCR processing is subjected to masking. With the first embodiment-based configuration, the scan apparatus 102 executes OCR processing and masking. With the second embodiment-based configuration, OCR processing may be performed by the scan apparatus 102 or the extended application 204, and masking is performed by the extended application 204.

In the case of these configurations, it is not necessary to perform a preview scan, so it is possible to shorten the work time.

### Sixth Embodiment

In the sixth embodiment, a further configuration regarding the preview function in the first embodiment will be described. Hereinafter, only the differences from the above-described embodiments will be described.

A method of, when the preview image is displayed in S612 of FIG. 6 and then there are any changes in the settings in S613, updating the preview image with the image data editing unit 207 of the extended application 204 if the image data editing unit 207 can execute image processing will be described. In this case, the scan apparatus 102 does not need to perform a scan again. The updated preview image differs from actual final image data; however, the image of a product can be easily and quickly provided to the user. For example, for a color mode setting, it is possible to visualize how the image changes by changing the setting value.

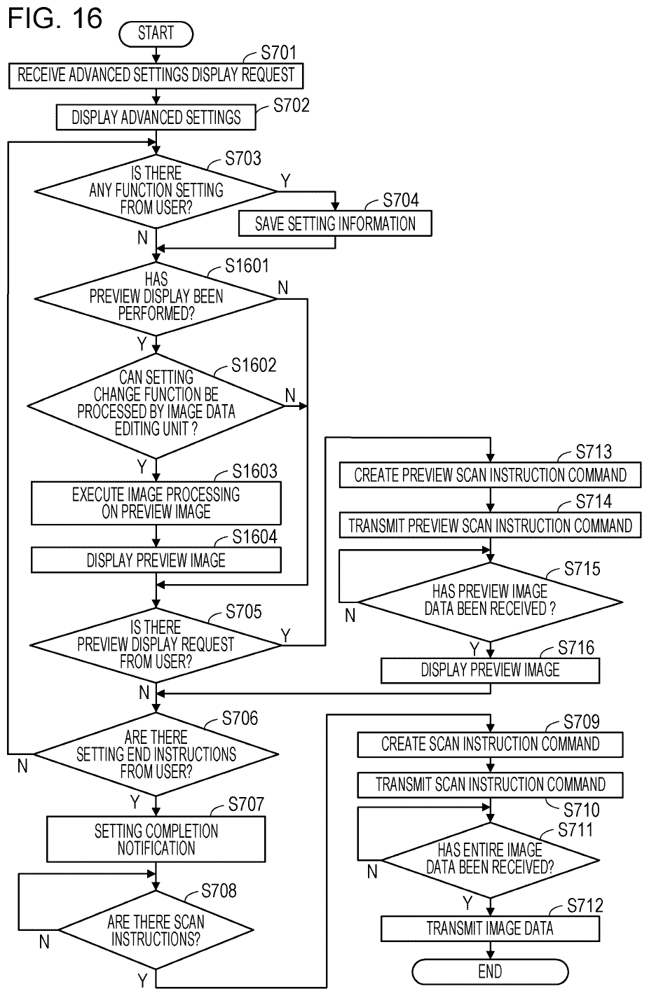

The flow in which the extended application 204 updates a preview image will be described with reference to FIG. 16.

FIG. 16 is a flowchart that shows an example of a process in which the extended application 204 according to the sixth embodiment updates a preview image. Steps are implemented by the CPU 111 executing the units read from the external storage device 114 onto the RAM 113. Like step numbers are assigned to the same steps as those of FIG. 7.

The extended application 204 saves the advanced settings received from the user in S704 and then advances the process to S1601.

In S1601, the extended application 204 determines whether the preview image has been displayed. Here, when the preview image has not been displayed yet (when the determination is negative in S1601), the scan settings screen extension unit 205 advances the process to S705.

On the other hand, when the preview image has already been displayed (when the determination is affirmative in S1601), the scan settings screen extension unit 205 advances the process to S1602.

In S1602, the extended application 204 determines whether the setting change function received in S703 can be processed by the image data editing unit 207. Here, when the setting change function cannot be processed by the image data editing unit 207 (when the determination is negative in S1602), the scan settings screen extension unit 205 advances the process to S705.

On the other hand, when the setting change function can be processed by the image data editing unit 207 (when the determination is affirmative in S1602), the scan settings screen extension unit 205 advances the process to S1603. For example, the color mode setting can be processed by the image data editing unit 207, so the process proceeds to S1603.

In S1603, the image data editing unit 207 performs image processing on the preview image.

Subsequently, in S1604, the extended application 204 displays the preview image data subjected to image processing in S1603 and advances the process to S705.

Next, the configuration in which, when the preview image is displayed and then the user determines to save the previewed image data as image data, a scan is not performed again and the preview image is actually passed to the scan application 201 will be described.

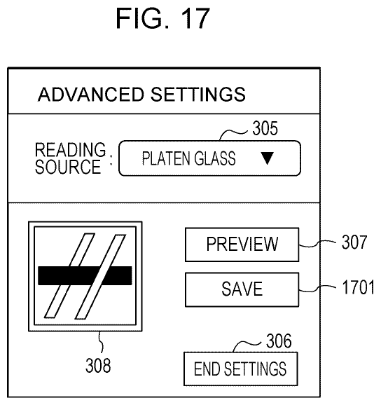

FIG. 17 is a diagram that shows an example of an advanced settings screen on which instructions to save a preview image can be provided.

The advanced settings screen shown in FIG. 17 displays a control (1701) for providing instructions to save a preview image. When the control 1701 is pressed, the extended application 204 executes a process of saving a preview image.

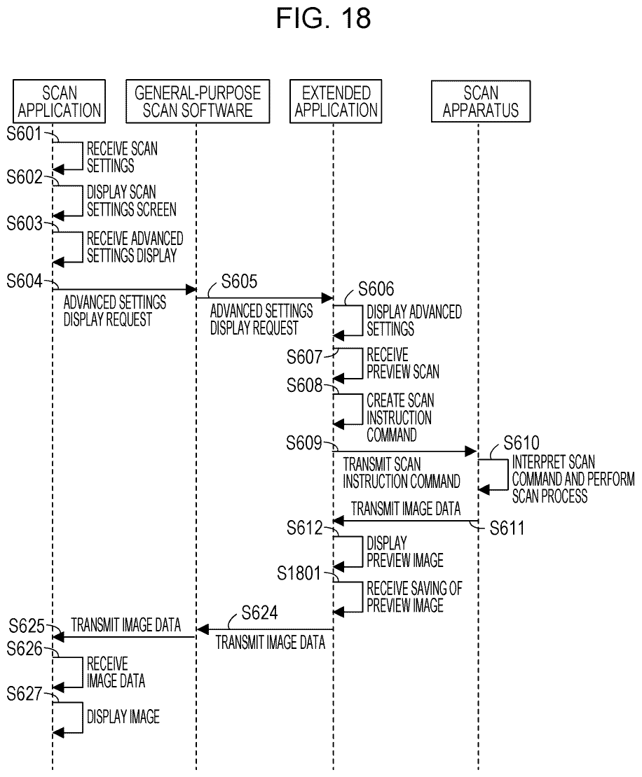

The sequence of the scan application 201, the general-purpose scan software 202, the extended application 204, and the scan apparatus 102 after the scan application 201 receives scan settings in a case where a preview is saved will be described with reference to FIG. 18.

FIG. 18 is a diagram that illustrates the sequence of the scan application 201, the general-purpose scan software 202, the extended application 204, and the scan apparatus 102 after the scan application 201 receives scan settings in a case where a preview is saved in the sixth embodiment. Steps other than steps performed by the scan apparatus 102 in FIG. 18 are implemented by the CPU 111 reading the scan application 201, the general-purpose scan software 202, and the extended application 204 from the external storage device 114 onto the RAM 113 and launching the software. Steps performed by the scan apparatus 102 in FIG. 18 are implemented by the CPU 191 of the scan apparatus 102 reading a program stored in the ROM 192 or the external storage device 199 onto the RAM 193 and running the program. Like step numbers are assigned to the same steps as those of FIG. 6.

When the extended application 204 of the sixth embodiment displays the preview image in the preview image display region 308 in S612, the extended application 204 executes control such that saving of the preview image can be received.

The user is able to provide instructions for saving the preview image by operating the pointing device 117 and the keyboard 118 to select the control 1706. When instructions to save the preview image are provided, the extended application 204 receives saving of the preview image in S1801 and advances the process to S624. In S624, the extended application 204 passes the image data of the preview image to the general-purpose scan software 202. Then, when the general-purpose scan software 202 passes the image data to the scan application 201 (S625), the scan application 201 can handle the image data of the preview image.

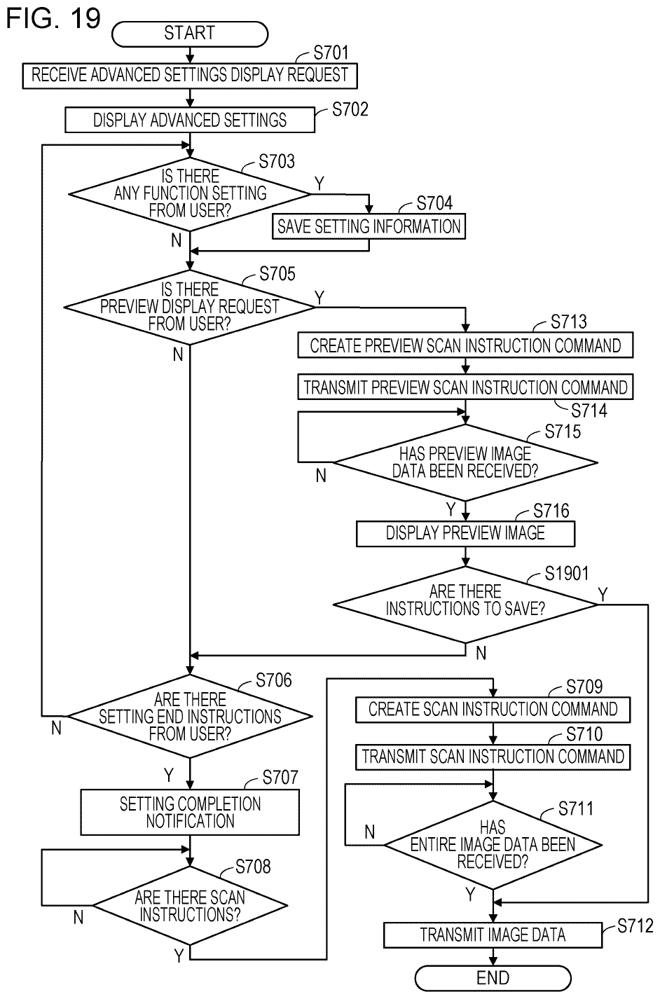

Here, the flow in which the extended application 204 executes a scan process will be described with reference to FIG. 19.

FIG. 19 is a flowchart that shows an example of the scan process executed by the extended application 204 according to the sixth embodiment. Steps are implemented by the CPU 111 executing the units read from the external storage device 114 onto the RAM 113. Like step numbers are assigned to the same steps as those of FIG. 7.

When the extended application 204 according to the sixth embodiment displays the preview image data in the preview image display region 308 in S716, the extended application 204 advances the process to S1901.

In S1901, the scan settings screen extension unit 205 of the extended application 204 determines whether there is a request from the user to save the preview image. Here, when there is no request from the user to save the preview image (when the determination is negative in S1901), the scan settings screen extension unit 205 advances the process to S706.

On the other hand, when there is a request from the user to save the preview image (when the determination is affirmative in S1901), the scan settings screen extension unit 205 advances the process to S712. In this case, in S712, the extended application 204 transmits the preview image to the general-purpose scan software 202. Thus, after preview display, it is possible to directly save the preview image data as a read image without performing a scan again.

Next, the configuration in which actual document data is not used as a preview image and a preview is displayed by using predetermined image data held in advance inside the extended application 204 will be described. By using image data held in advance, it is possible to easily and quickly provide the user with the image of a product without the need of the scan process although the image data is different from the actual image data. For example, for a color mode setting, it is possible to visualize how the image changes by changing the setting value.

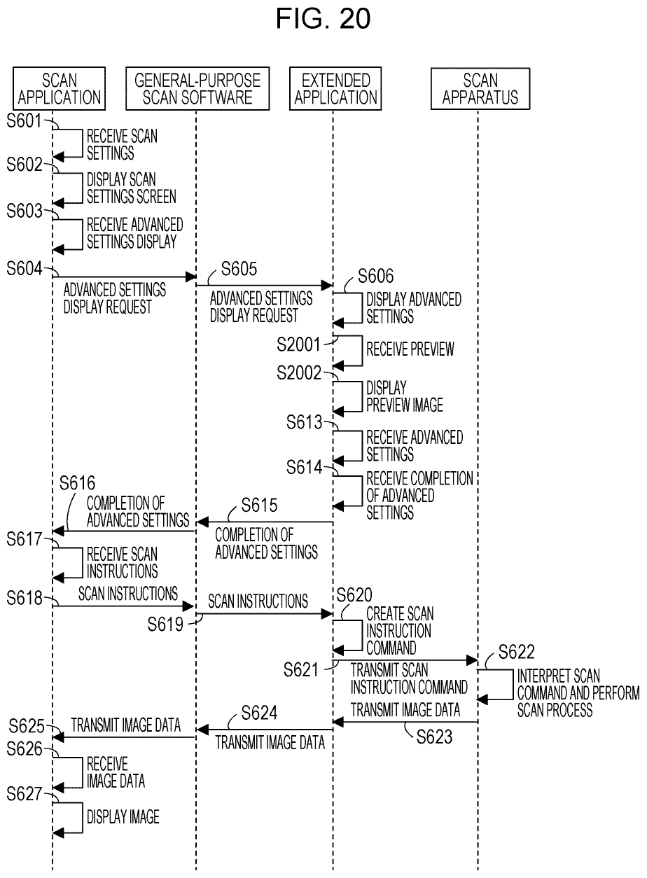

The sequence of the scan application 201, the general-purpose scan software 202, the extended application 204, and the scan apparatus 102 in a case where a preview image held in advance is displayed will be described with reference to FIG. 20.

FIG. 20 is a diagram that illustrates the sequence of the scan application 201, the general-purpose scan software 202, the extended application 204, and the scan apparatus 102 in a case where a preview image held in advance is displayed. Steps other than steps performed by the scan apparatus 102 in FIG. 20 are implemented by the CPU 111 reading the scan application 201, the general-purpose scan software 202, and the extended application 204 from the external storage device 114 onto the RAM 113 and launching the software. Steps performed by the scan apparatus 102 in FIG. 20 are implemented by the CPU 191 of the scan apparatus 102 reading a program stored in the ROM 192 or the external storage device 199 onto the RAM 193 and running the program. Like step numbers are assigned to the same steps as those of FIG. 6.

In a case where a preview image held in advance is displayed, when the scan settings screen extension unit 205 of the extended application 204 causes the display unit 119 to display the advanced settings screen in S606, the scan settings screen extension unit 205 executes control such that the preview instruction button 307 can receive display of the preview image.

When the extended application 204 receives display of the preview image through the preview instruction button 307 in S2001, the extended application 204 advances the process to S2002.

In S2002, the extended application 204 displays the preview image corresponding to the received settings. The preview image displayed at this time may be configured such that multiple different preview images are held in the external storage device 114 or the like according to various settings and an image according to the settings is displayed from among the images or may be configured such that specific preview image data is subjected to image processing each time and displayed.

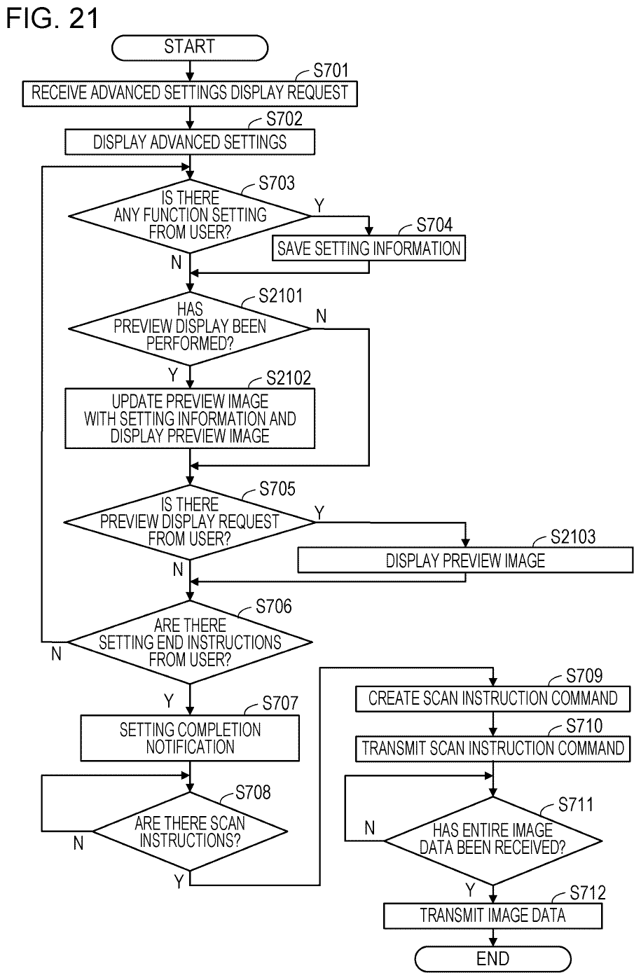

Hereinafter, the flow in which the extended application 204 updates a preview image will be described with reference to FIG. 21.

FIG. 21 is a flowchart that shows an example of a process in which the extended application 204 updates a preview image. Steps are implemented by the CPU 111 executing the units read from the external storage device 114 onto the RAM 113.

When a preview image held in advance is displayed, the extended application 204 saves the advanced settings received from the user in S704 and then advances the process to S2101.

In S2101, the extended application 204 determines whether the preview display has been performed. Here, when the preview display has not been performed yet (when the determination is negative in S2101), the extended application 204 advances the process to S705.

On the other hand, when the preview display has been performed (when the determination is affirmative in S2101), the extended application 204 advances the process in S2102.

In S2102, the extended application 204 updates and displays the preview image according to the settings and advances the process to S705.

When there is a preview display request from the user (when the determination is affirmative in S705), the extended application 204 advances the process to S2103.

In S2103, the extended application 204 displays a preview image according to the settings and advances the process to S706.

As described above, in the sixth embodiment, the preview image is displayed by the extended application 204. Then, by changing the preview image according to the settings, the user is able to easily visualize a final product.

In accordance with the capability response of the scan apparatus, whether to perform a preview scan and perform preview display or to perform preview display using predetermined image data held in advance may be switched. For example, the extended application 204 executes control to perform a preview scan and perform preview display when the scan apparatus 102 supports the preview function or to perform preview display using predetermined image data held in advance when the scan apparatus 102 does not support the preview function.

As described above, even when the general-purpose scan software 202 which is commonly able to be used with scan apparatuses supplied from a plurality of manufacturers does not support a cropping function, it is possible to enable the cropping function for the user with a program (extended application) that extends and supports the functions of the general-purpose scan software 202.

Even when the general-purpose scan software 202 which is commonly able to be used with scan apparatuses supplied from a plurality of manufacturers does not support a masking function, it is possible to enable the masking function for the user with a program (extended application) that extends and supports the functions of the general-purpose scan software 202.

In other words, even when the general-purpose scan software 202 which is commonly able to be used with scan apparatuses supplied from a plurality of manufacturers does not support functions to hide part of a read image, such as a cropping function and a masking function, it is possible to allow the user to use the functions to hide part of a read image with a program (extended application) that extends and supports the functions of the general-purpose scan software 202.

Even when the general-purpose scan software 202 which is commonly able to be used with scan apparatuses supplied from a plurality of manufacturers does not support a preview function, it is possible to enable the preview function for the user with a program (extended application) that extends and supports the functions of the general-purpose scan software 202.

In this way, even when the general-purpose scan software 202 which is commonly able to be used with scan apparatuses supplied from a plurality of manufacturers does not support a function, it is possible to enable the function for the user with a program (extended application) that extends and supports the functions of the general-purpose scan software 202.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-053436, filed Mar. 28, 2024, which is hereby incorporated by reference herein in its entirety.

What is claimed is:

1. A non-transitory computer-readable storage medium storing an application program which causes an information processing apparatus to perform a control method, the application program supporting scan software which is able to be used with a plurality of image processing apparatuses supplied from a plurality of manufacturers, the control method comprising:
displaying a display screen that receives a setting to hide part of a read image; and
outputting reading instructions to an image reading apparatus to perform a scan in accordance with the setting received on the display screen.

2. The non-transitory computer-readable storage medium according to claim 1, the control method further comprising
instructing the image reading apparatus that performs the scan, to perform a preview scan, and displaying an image obtained through the preview scan as a preview image on the display screen, wherein
the display screen receives the setting to be designated in accordance with a region designated on the preview image.

3. The non-transitory computer-readable storage medium according to claim 2, wherein
in the display screen, a region that is hidden through the setting is displayed in the preview image.

4. The non-transitory computer-readable storage medium according to claim 2, wherein
the display screen receives display instructions to display a preview image of a read image, and
the preview image is displayed in response to the display instructions.

5. The non-transitory computer-readable storage medium according to claim 1, wherein
the display screen receives the setting in numeric values that are respectively designated to indicate a position and size of a region to be hidden.

6. The non-transitory computer-readable storage medium according to claim 1, wherein
the display screen receives the setting in numeric values that are respectively designated to indicate a starting point and end point of a region to be hidden.

7. The non-transitory computer-readable storage medium according to claim 1, the control method further comprising
when the setting received on the display screen is not a setting that can be performed by the image reading apparatus that performs a scan, executing processing according to the setting on an image read by the image reading apparatus.

8. The non-transitory computer-readable storage medium according to claim 7, wherein
when the setting received on the display screen is not a setting that can be performed by the image reading apparatus that performs a scan, the reading instructions do not include instructions corresponding to the setting.

9. The non-transitory computer-readable storage medium according to claim 1, wherein
the reading instructions corresponding to the setting are provided using a command different from a command that conforms with a standard protocol.

10. The non-transitory computer-readable storage medium according to claim 1, wherein
a setting item to be displayed on the display screen is changed according to capabilities of the image reading apparatus that performs a scan.

11. The non-transitory computer-readable storage medium according to claim 1, wherein
the setting to hide part of a read image is a cropping setting.

12. The non-transitory computer-readable storage medium according to claim 1, wherein
the setting to hide part of a read image is a masking setting.

13. The non-transitory computer-readable storage medium according to claim 12, wherein
the masking setting that can be received on the display screen includes information about a color to be masked, and
when the masking setting received on the display screen includes the information about a color to be masked, reading instructions based on the information about a color to be masked are incorporated in the reading instructions.

14. A non-transitory computer-readable storage medium storing an application program which causes an information processing apparatus to perform a control method, the application program supporting scan software which is able to be used with a plurality of image processing apparatuses supplied from a plurality of manufacturers, the control method comprising:
displaying a display screen that receives a reading setting and display instructions to display a preview image of a read image; and
outputting instructions to an image reading apparatus to perform a preview scan in response to the display instructions to display a preview image on the display screen, and displaying an image obtained through the preview scan as the preview image on the display screen.

15. The non-transitory computer-readable storage medium according to claim 14, the control method further comprising
executing processing according to the setting received on the display screen on image data obtained through the preview scan.

16. The non-transitory computer-readable storage medium according to claim 14, wherein the display screen is capable of receiving whether to save the preview image as a read image,
the control method further comprising
when saving of the preview image is received on the display screen, saving the preview image as a read image.

17. The non-transitory computer-readable storage medium according to claim 14, further comprising in accordance with capabilities of the image reading apparatus that performs a scan, switching whether to perform the preview scan to display an image obtained through the preview scan as a preview image or to display predetermined image data as a preview image.

18. An information processing method in a computer that supports functions of general-purpose scan software which is commonly able to be used with image reading apparatuses supplied from a plurality of manufacturers, the information processing method comprising:
displaying a display screen that receives a setting to hide part of a read image; and
outputting reading instructions to an image reading apparatus to perform a scan in accordance with the setting received on the display screen.

19. The information processing method according to claim 18, wherein the setting to hide part of a read image is a cropping setting.

20. The information processing method according to claim 18, wherein the setting to hide part of a read image is a masking setting.

21. An information processing method in a computer that supports functions of general-purpose scan software which is commonly able to be used with image reading apparatuses supplied from a plurality of manufacturers, the information processing method comprising:
displaying a display screen that receives a reading setting and display instructions to display a preview image of a read image; and
outputting instructions to an image reading apparatus to perform a preview scan in response to the display instructions to display a preview image on the display screen, and displaying an image obtained through the preview scan as the preview image on the display screen.

22. An information processing apparatus that supports functions of general-purpose scan software which is commonly able to be used with image reading apparatuses supplied from a plurality of manufacturers, the information processing apparatus comprising:
a display unit configured to display a display screen that receives a setting to hide part of a read image; and
an instruction unit configured to output reading instructions to an image reading apparatus to perform a scan in accordance with the setting received on the display screen.

23. The information processing apparatus according to claim 22, wherein the setting to hide part of a read image is a cropping setting.

24. The information processing apparatus according to claim 22, wherein the setting to hide part of a read image is a masking setting.

25. An information processing apparatus that supports functions of general-purpose scan software which is commonly able to be used with image reading apparatuses supplied from a plurality of manufacturers, the information processing apparatus comprising:
a first display unit configured to display a display screen that receives a reading setting and display instructions to display a preview image of a read image; and
a second display unit configured to output instructions to an image reading apparatus to perform a preview scan in response to the display instructions to display a preview image on the display screen, and to display an image obtained through the preview scan as the preview image on the display screen.
